(19) United States
(12) Patent Application Publication
(10) Pub. No.: US 2023/0376765 A1
(43) Pub. Date: Nov. 23, 2023

(54) PERFORMING OPERATION IN NEURAL NETWORK WITH STORAGE POINTER AND SPARSITY MAP

(71) Applicants: Jyoti Wagholikar, Santa Clara, CA (US); Muralidhar Ambati, Hillsboro, OR (US); Alessandro Palla, Pisa (IT); Rutvi Trivedi, San Jose, CA (US); Darren Crews, Portland, OR (US)

(72) Inventors: Jyoti Wagholikar, Santa Clara, CA (US); Muralidhar Ambati, Hillsboro, OR (US); Alessandro Palla, Pisa (IT); Rutvi Trivedi, San Jose, CA (US); Darren Crews, Portland, OR (US)

(21) Appl. No.: 18/364,814

(22) Filed: Aug. 3, 2023

(51) Int. Cl. G06N 3/08

(52) U.S. Cl. CPC G06N 3/08

(57) ABSTRACT

Deep learning operations (e.g., transposed convolution, resized convolution, dilated convolution, etc.) may be performed with sparsity maps and storage pointers. A deep learning operation has a tensor, which can be used to generate an upsampled tensor by adding new data elements (e.g., zeros) into the tensor. One or more sparsity maps may be generated based on one or more parameters of the first deep learning operation. The sparsity map may include elements indicating whether a data element in the upsampled tensor is a data element in the tensor or is a new data element. One or more storage pointers may be generated. A storage pointer may indicate a location (e.g., a memory address) where one or more data elements of the tensor are stored in a memory. An output of the deep learning operation may be performed using data elements in the tensor, the sparsity maps, and the storage pointers.

### TECHNICAL FIELD

This disclosure relates generally to deep neural networks (DNNs, also referred to as neural networks), and more specifically, performing operations in DNNs with storage pointers and sparsity maps.

### BACKGROUND

DNNs are used extensively for a variety of artificial intelligence applications ranging from computer vision to speech recognition and natural language processing due to their ability to achieve high accuracy. However, the high accuracy comes at the expense of significant computation cost. DNNs have extremely high computing demands as each inference can require hundreds of millions of MAC (multiply-accumulate) operations as well as a large amount of data to read and write. DNN inference also requires computation of activation functions. Therefore, techniques to improve efficiency of DNNs are needed.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an example DNN, in accordance with various embodiments.

FIG. 2A is a block diagram of a DNN system, in accordance with various embodiments.

FIG. 2B is a block diagram of a DNN module, in accordance with various embodiments.

FIG. 2C illustrates a local memory, in accordance with various embodiments.

FIG. 3 illustrates an MAC operation facilitated by storage pointers, in accordance with various embodiments.

FIG. 4 illustrates a convolution and a transposed convolution, in accordance with various embodiments.

FIG. 5 illustrates expansion of an input tensor, in accordance with various embodiments.

FIGS. 6A and 6B illustrate a transposed convolution converted to a convolution, in accordance with various embodiments.

FIGS. 7A-7D illustrate a resized and dilated convolution, in accordance with various embodiments.

FIG. 8 illustrates an example convolution, in accordance with various embodiments.

FIG. 9 illustrates an example processing element (PE) array, in accordance with various embodiments.

FIG. 10 is a block diagram of a PE, in accordance with various embodiments.

FIG. 11 is a flowchart showing a method of performing deep learning operations, in accordance with various embodiments.

FIG. 12 is a block diagram of an example computing device, in accordance with various embodiments.

### DETAILED DESCRIPTION

### Overview

The last decade has witnessed a rapid rise in AI (artificial intelligence) based data processing, particularly based on DNNs. DNNs are widely used in the domains of computer vision, speech recognition, image, and video processing mainly due to their ability to achieve beyond human-level accuracy. The significant improvements in DNN model size and accuracy coupled with the rapid increase in computing power of execution platforms have led to the adoption of DNN applications even within resource constrained mobile and edge devices that have limited energy availability.

A DNN layer may include one or more deep learning operations, such as convolution, pooling, elementwise operation, linear operation, nonlinear operation, and so on. A deep learning operation in a DNN may be performed on one or more internal parameters of the DNNs (e.g., weights), which are determined during the training phase, and one or more activations. An activation may be a data point (also referred to as “data elements” or “elements”). Activations or weights of a DNN layer may be elements of a tensor of the DNN layer. A tensor is a data structure having multiple elements across one or more dimensions. Example tensors include a vector, which is a one-dimensional tensor, and a matrix, which is a two-dimensional tensor. There can also be three-dimensional tensors and even higher dimensional tensors. A DNN layer may have an input tensor (also referred to as “input feature map (IFM)”) including one or more input activations (also referred to as “input elements”) and a weight tensor including one or more weights. A weight is an element in the weight tensor. A weight tensor of a convolution may be a kernel, a filter, or a group of filters. The output data of the DNN layer may be an output tensor (also referred to as “output feature map (OFM)”) that includes one or more output activations (also referred to as “output elements”).

Many deep learning operations require pre-processing tensors. For example, transposed convolution (also referred to as “deconvolution” or “inverse convolution”) and resized convolution (e.g., resized through padding) require inserting zeros between rows and columns in input tensors. As another example, dilated convolutions require slicing the data, computing convolutions, and concatenating the outputs of the convolutions. Such pre-processing steps can cause additional latency and increase memory footprint. Software layers (mapped to DSPs (Digital Signal Processors)) and Direct Memory Access (DMAs) have been used for the pre-processing steps.

However, there is usually an inherent cost that depends on the steps involved in such operations. The operations involved are like split, concatenations, or zero expansion of the tensors with respect to input. For instance, insertion of zeros for transposed or resized convolution can involve multiple DMA operations and increase memory footprint. Also, it cannot take advantage of sparse compute acceleration. Whereas for dilated convolution, data split and concatenation can be costly.

Embodiments of the present disclosure may improve on at least some of the challenges and issues described above by performing deep learning operations in DNNs with storage pointers (also referred to as “storage element pointers” or “storage unit pointers”). A DNN may include various deep learning operations including convolutions and variants of convolutions (also referred to as “convolution variants”). Examples of convolution variants include transposed convolution, resized convolution, dilated convolution, and so on. Computations in a convolution variant may be performed based on one or more sparsity maps and one or more storage pointers to reduce memory footprint and accelerate the computations.

In various embodiments of the present disclosure, a deep learning operation in a DNN may have a tensor. The tensor may be an input tensor including one or more activations or a filter including one or more weights. The deep learning operation may include expanding the tensor into an upsampled tensor (also referred to as a padded tensor) by adding new data elements (e.g., zeros) into the tensor. A sparsity map may be generated based on one or more hyperparameters of the deep learning operation, such as kernel size, padding size, stride size, dilation rate, and so on. The sparsity map may include elements indicating whether a data element in the upsampled tensor is a data element in the tensor or is a new data element. In an example, the sparsity map may include bits, a bit of one may indicate that the corresponding data element of the upsampled tensor is a data element in the tensor versus a bit of zero indicates that the corresponding data element of the upsampled tensor is a new data element.

One or more storage pointers may also be generated for the deep learning operation. A storage pointer may indicate a location (e.g., a memory address) where one or more data elements of the tensor are stored in a memory. An output of the deep learning operation may be computed using the data elements in the tensor, the sparsity map, and the storage pointers. For instance, the data elements in the tensor may be read from the memory based on the storage pointers. The sparsity map may be used to determine the positions of the data elements in the upsampled tensor for performing MAC operations in the deep learning operation. By using sparsity maps and storage pointers, pre-processing for performing deep learning operation can be avoided. Also, memory footprint can be reduced as storage of zeros inserted into the tensors may not be required. Further, compute efficiency can be improved as computations of the zeros can be avoided.

For purposes of explanation, specific numbers, materials and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, device, or DNN accelerator that comprises a list of elements is not necessarily limited to only those elements but may include other elements not expressly listed or inherent to such method, process, device, or DNN accelerators. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description below and the accompanying drawings.

### Example DNN

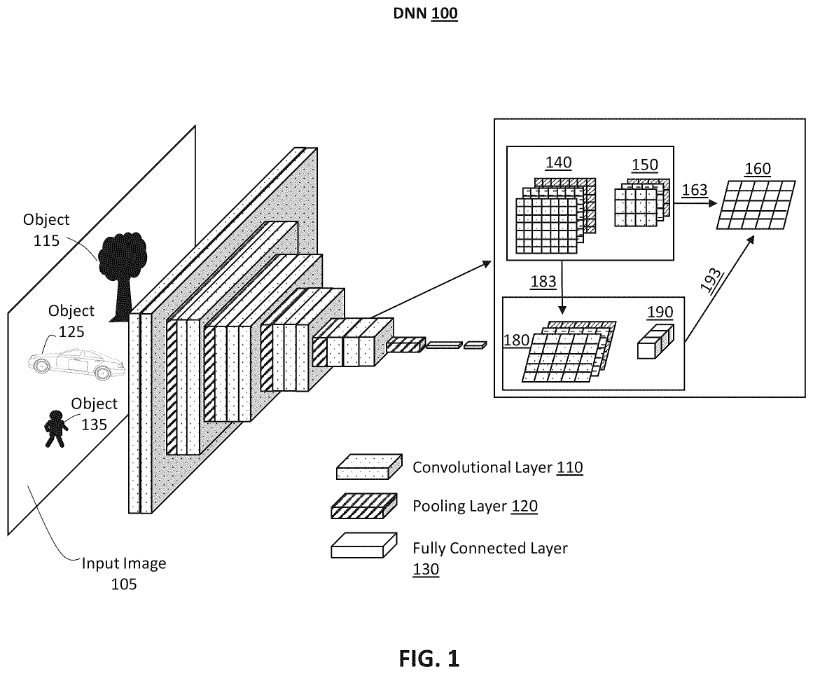

FIG. 1 illustrates an example DNN 100, in accordance with various embodiments. For purpose of illustration, the DNN 100 in FIG. 1 is a CNN. In other embodiments, the DNN 100 may be other types of DNNs. The DNN 100 is trained to receive images and output classifications of objects in the images. In the embodiments of FIG. 1, the DNN 100 receives an input image 105 that includes objects 115, 125, and 135. The DNN 100 includes a sequence of layers comprising a plurality of convolutional layers 110 (individually referred to as “convolutional layer 110”), a plurality of pooling layers 120 (individually referred to as “pooling layer 120”), and a plurality of fully connected layers 130 (individually referred to as “fully connected layer 130”). In other embodiments, the DNN 100 may include fewer, more, or different layers. In an inference of the DNN 100, the layers of the DNN 100 execute tensor computation that includes many tensor operations, such as convolution (e.g., multiply-accumulate (MAC) operations, etc.), pooling operations, elementwise operations (e.g., elementwise addition, elementwise multiplication, etc.), other types of tensor operations, or some combination thereof.

The convolutional layers 110 summarize the presence of features in the input image 105. The convolutional layers 110 function as feature extractors. The first layer of the DNN 100 is a convolutional layer 110. In an example, a convolutional layer 110 performs a convolution on an input tensor 140 (also referred to as IFM 140) and a filter 150. As shown in FIG. 1, the IFM 140 is represented by a 7×7×3 three-dimensional (3D) matrix. The IFM 140 includes 3 input channels, each of which is represented by a 7×7 two-dimensional (2D) matrix. The 7×7 2D matrix includes 7 input elements (also referred to as input points) in each row and 7 input elements in each column. The filter 150 is represented by a 3×3×3 3D matrix. The filter 150 includes 3 kernels, each of which may correspond to a different input channel of the IFM 140. A kernel is a 2D matrix of weights, where the weights are arranged in columns and rows. A kernel can be smaller than the IFM. In the embodiments of FIG. 1, each kernel is represented by a 3×3 2D matrix. The 3×3 kernel includes 3 weights in each row and 3 weights in each column. Weights can be initialized and updated by backpropagation using gradient descent. The magnitudes of the weights can indicate importance of the filter 150 in extracting features from the IFM 140.

The convolution includes MAC operations with the input elements in the IFM 140 and the weights in the filter 150. The convolution may be a standard convolution 163 or a depthwise convolution 183. In the standard convolution 163, the whole filter 150 slides across the IFM 140. All the input channels are combined to produce an output tensor 160 (also referred to as output feature map (OFM) 160). The OFM 160 is represented by a 5×5 2D matrix. The 5×5 2D matrix includes 5 output elements (also referred to as output points) in each row and 5 output elements in each column. For purpose of illustration, the standard convolution includes one filter in the embodiments of FIG. 1. In embodiments where there are multiple filters, the standard convolution may produce multiple output channels in the OFM 160.

The multiplication applied between a kernel-sized patch of the IFM 140 and a kernel may be a dot product. A dot product is the elementwise multiplication between the kernel-sized patch of the IFM 140 and the corresponding kernel, which is then summed, always resulting in a single value. Because it results in a single value, the operation is often referred to as the “scalar product.” Using a kernel smaller than the IFM 140 is intentional as it allows the same kernel (set of weights) to be multiplied by the IFM 140 multiple times at different points on the IFM 140. Specifically, the kernel is applied systematically to each overlapping part or kernel-sized patch of the IFM 140, left to right, top to bottom. The result from multiplying the kernel with the IFM 140 one time is a single value. As the kernel is applied multiple times to the IFM 140, the multiplication result is a 2D matrix of output elements. As such, the 2D output matrix (i.e., the OFM 160) from the standard convolution 163 is referred to as an OFM.

In the depthwise convolution 183, the input channels are not combined. Rather, MAC operations are performed on an individual input channel and an individual kernel and produce an output channel. As shown in FIG. 1, the depthwise convolution 183 produces a depthwise output tensor 180. The depthwise output tensor 180 is represented by a 5×5×3 3D matrix. The depthwise output tensor 180 includes 3 output channels, each of which is represented by a 5×5 2D matrix. The 5×5 2D matrix includes 5 output elements in each row and 5 output elements in each column. Each output channel is a result of MAC operations of an input channel of the IFM 140 and a kernel of the filter 150. For instance, the first output channel (patterned with dots) is a result of MAC operations of the first input channel (patterned with dots) and the first kernel (patterned with dots), the second output channel (patterned with horizontal strips) is a result of MAC operations of the second input channel (patterned with horizontal strips) and the second kernel (patterned with horizontal strips), and the third output channel (patterned with diagonal stripes) is a result of MAC operations of the third input channel (patterned with diagonal stripes) and the third kernel (patterned with diagonal stripes). In such a depthwise convolution, the number of input channels equals the number of output channels, and each output channel corresponds to a different input channel. The input channels and output channels are referred to collectively as depthwise channels. After the depthwise convolution, a pointwise convolution 193 is then performed on the depthwise output tensor 180 and a 1×1×3 tensor 190 to produce the OFM 160.

The OFM 160 is then passed to the next layer in the sequence. In some embodiments, the OFM 160 is passed through an activation function. An example activation function is the rectified linear activation function (ReLU). ReLU is a calculation that returns the value provided as input directly, or the value zero if the input is zero or less. The convolutional layer 110 may receive several images as input and calculate the convolution of each of them with each of the kernels. This process can be repeated several times. For instance, the OFM 160 is passed to the subsequent convolutional layer 110 (i.e., the convolutional layer 110 following the convolutional layer 110 generating the OFM 160 in the sequence). The subsequent convolutional layers 110 perform a convolution on the OFM 160 with new kernels and generates a new feature map. The new feature map may also be normalized and resized. The new feature map can be kernelled again by a further subsequent convolutional layer 110, and so on.

In some embodiments, a convolutional layer 110 has 4 hyperparameters: the number of kernels, the size F kernels (e.g., a kernel is of dimensions F×F×D pixels), the S step with which the window corresponding to the kernel is dragged on the image (e.g., a step of one means moving the window one pixel at a time), and the zero-padding P (e.g., adding a black contour of P pixels thickness to the input image of the convolutional layer 110). The convolutional layers 110 may perform various types of convolutions, such as 2-dimensional convolution, dilated or atrous convolution, spatial separable convolution, depthwise separable convolution, transposed convolution, and so on. The DNN 100 includes 16 convolutional layers 110. In other embodiments, the DNN 100 may include a different number of convolutional layers.

The pooling layers 120 down-sample feature maps generated by the convolutional layers, e.g., by summarizing the presence of features in the patches of the feature maps. A pooling layer 120 is placed between 2 convolution layers 110: a preceding convolutional layer 110 (the convolution layer 110 preceding the pooling layer 120 in the sequence of layers) and a subsequent convolutional layer 110 (the convolution layer 110 subsequent to the pooling layer 120 in the sequence of layers). In some embodiments, a pooling layer 120 is added after a convolutional layer 110, e.g., after an activation function (e.g., ReLU, etc.) has been applied to the OFM 160.

A pooling layer 120 receives feature maps generated by the preceding convolution layer 110 and applies a pooling operation to the feature maps. The pooling operation reduces the size of the feature maps while preserving their important characteristics. Accordingly, the pooling operation improves the efficiency of the DNN and avoids over-learning. The pooling layers 120 may perform the pooling operation through average pooling (calculating the average value for each patch on the feature map), max pooling (calculating the maximum value for each patch of the feature map), or a combination of both. The size of the pooling operation is smaller than the size of the feature maps. In various embodiments, the pooling operation is 2×2 pixels applied with a stride of 2 pixels, so that the pooling operation reduces the size of a feature map by a factor of 2, e.g., the number of pixels or values in the feature map is reduced to one quarter the size. In an example, a pooling layer 120 applied to a feature map of 6×6 results in an output pooled feature map of 3×3. The output of the pooling layer 120 is inputted into the subsequent convolution layer 110 for further feature extraction. In some embodiments, the pooling layer 120 operates upon each feature map separately to create a new set of the same number of pooled feature maps.

The fully connected layers 130 are the last layers of the DNN. The fully connected layers 130 may be convolutional or not. The fully connected layers 130 receive an input operand. The input operand defines the output of the convolutional layers 110 and pooling layers 120 and includes the values of the last feature map generated by the last pooling layer 120 in the sequence. The fully connected layers 130 apply a linear combination and an activation function to the input operand and generate a vector. The vector may contain as many elements as there are classes: element i represents the probability that the image belongs to class i. Each element is therefore between 0 and 1, and the sum of all is worth one. These probabilities are calculated by the last fully connected layer 130 by using a logistic function (binary classification) or a softmax function (multi-class classification) as an activation function.

In some embodiments, the fully connected layers 130 classify the input image 105 and return an operand of size N, where N is the number of classes in the image classification problem. In the embodiments of FIG. 1, N equals 3, as there are 3 objects 115, 125, and 135 in the input image. Each element of the operand indicates the probability for the input image 105 to belong to a class. To calculate the probabilities, the fully connected layers 130 multiply each input element by weight, make the sum, and then apply an activation function (e.g., logistic if N=2, softmax if N>2). This is equivalent to multiplying the input operand by the matrix containing the weights. In an example, the vector includes 3 probabilities: a first probability indicating the object 115 being a tree, a second probability indicating the object 125 being a car, and a third probability indicating the object 135 being a person. In other embodiments where the input image 105 includes different objects or a different number of objects, the individual values can be different.

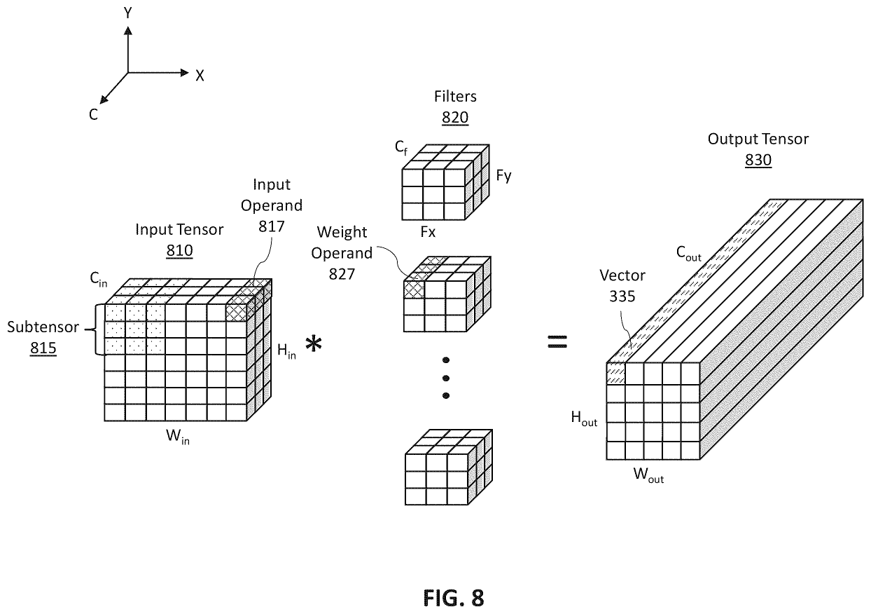

In addition to or alternative to convolution (e.g., standard convolution and depthwise convolution described above or the convolution 800 in FIG. 8), DNNs may include convolution variants, such as transposed convolution, resized convolution, or dilated convolution. A transposed convolution, which may also be referred to as an inverse convolution or transposed convolution, may be a reverse of a convolution. The input of a transposed convolution may be the same as an output of a convolution performed on the output of the transposed convolution. For instance, the IFM 140 may be an output of the transposed convolution, versus the OFM 160 may be an input of the transposed convolution. A resized convolution may include inserting zeros into its input tensor to generate an upsampled tensor and performing a convolution on the upsampled tensor to compute the output tensor of the resized convolution.

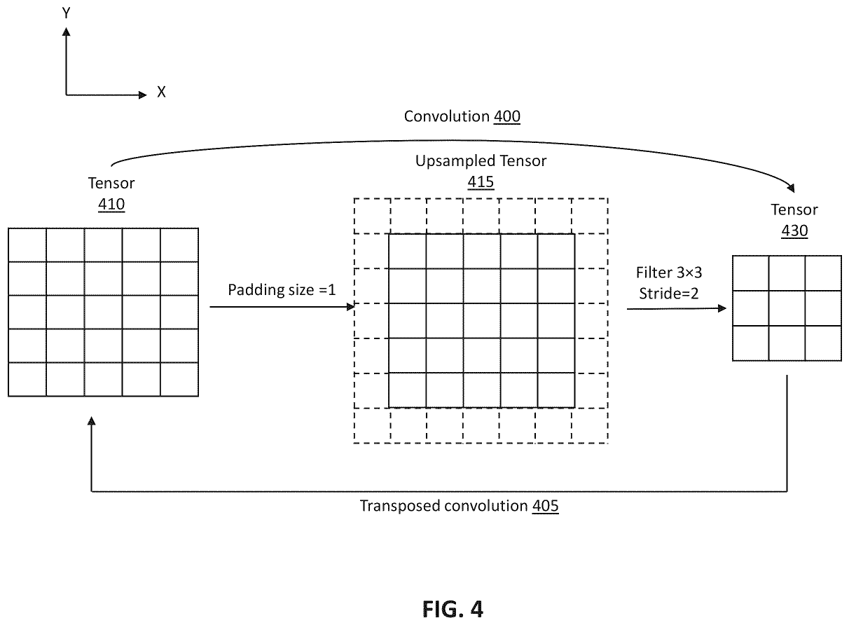

A transposed convolution or resized convolution may be performed by inserting zeros into the input tensor to generate an upsampled tensor and performing a convolution on the upsampled tensor to compute the output tensor. The transposed convolution or resized convolution may have a hyperparameter, e.g., a padding size, that indicates how many zeros to insert or where in the input tensor to insert zeros. The input tensor of a transposed convolution or resized convolution may have a smaller size than the output tensor of the transposed convolution or resized convolution, versus the input tensor of a convolution is usually larger than the output tensor of the convolution. The upsampled tensor may have a larger size than the input tensor of the transposed convolution or resized convolution. More details regarding transposed convolution and resized convolution are provided below in conjunction with FIGS. 4, 5, 6A, and 6B.

A dilated convolution, which may also be referred to as atrous convolution, is another variant of regular convolution. A dilated convolution may expand the kernel by inserting “gaps” between the weights in the kernel. The dilated kernel may be applied on the input tensor to compute the output tensor of the dilated convolution. In the dilated convolution, the gaps in the dilated kernel are not multiplied with activations in the input tensor. The dilation of the kernel can increase the receptive field of the kernel without increasing the number of weights. In some embodiments, a gap may be a value of zero.

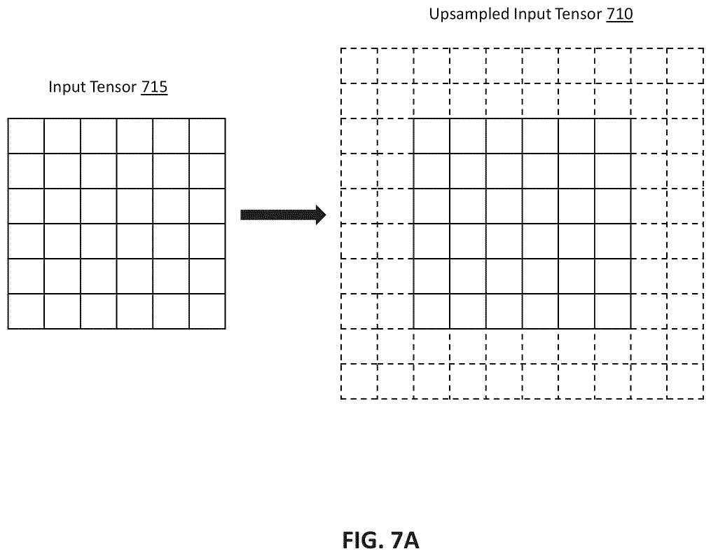

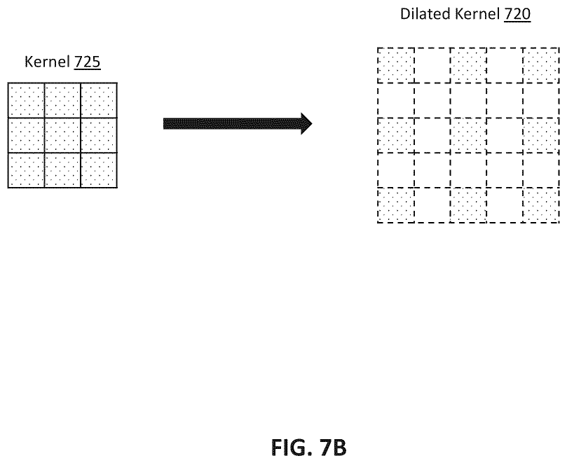

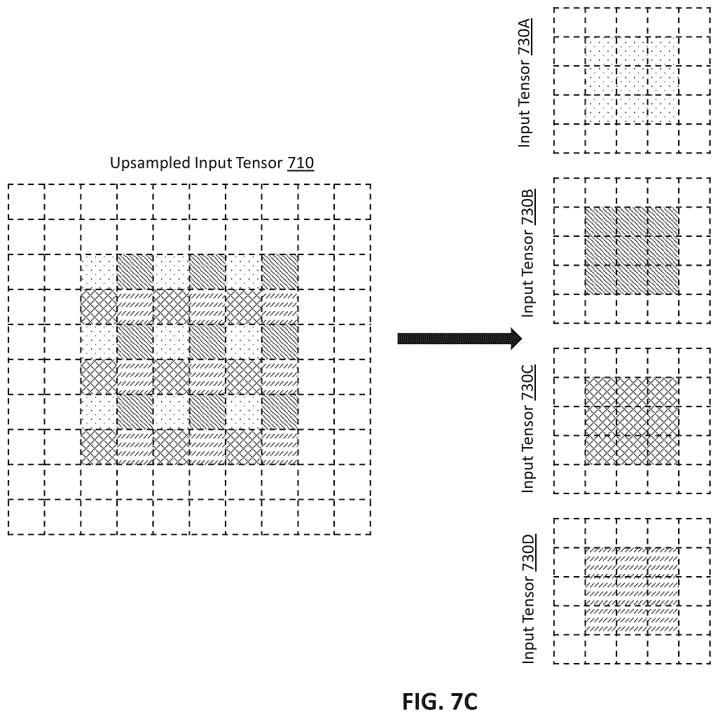

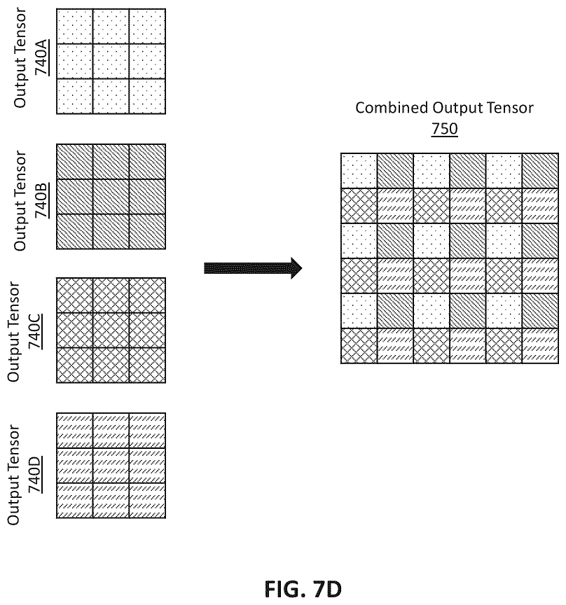

A dilation convolution may have a hyperparameter, e.g., a dilation rate, that indicates how much the kernel is expanded, e.g., how many zero(s) are inserted between two neighboring weights. When the dilation rate is D, the number of zeros inserted between two neighboring weights is D−1. In an example where the dilation rate is one, the dilated convolution reduces to a regular convolution, i.e., no zeros are inserted into the kernel. In another example where the dilation rate is two, a zero may be inserted between any two neighboring weights. For instance, a kernel including four weights may be expanded to a tensor of nine elements that includes the four weights and five zeros. More details regarding transposed convolution and resized convolution are provided below in conjunction with FIGS. 7A and 7B.

### Example DNN System

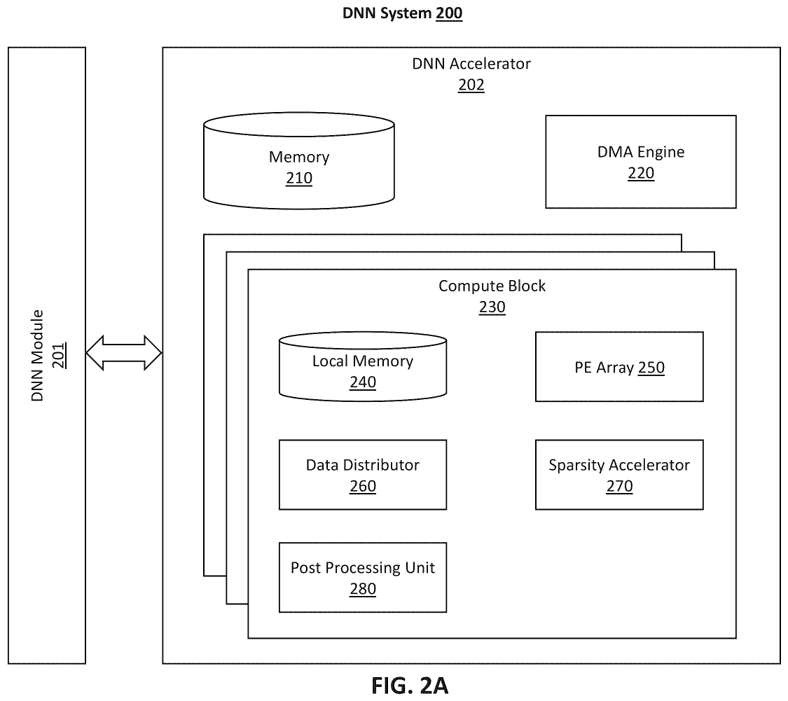

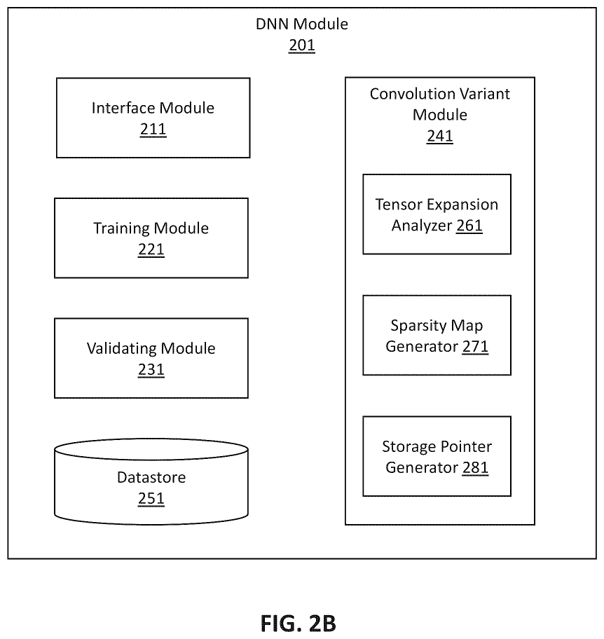

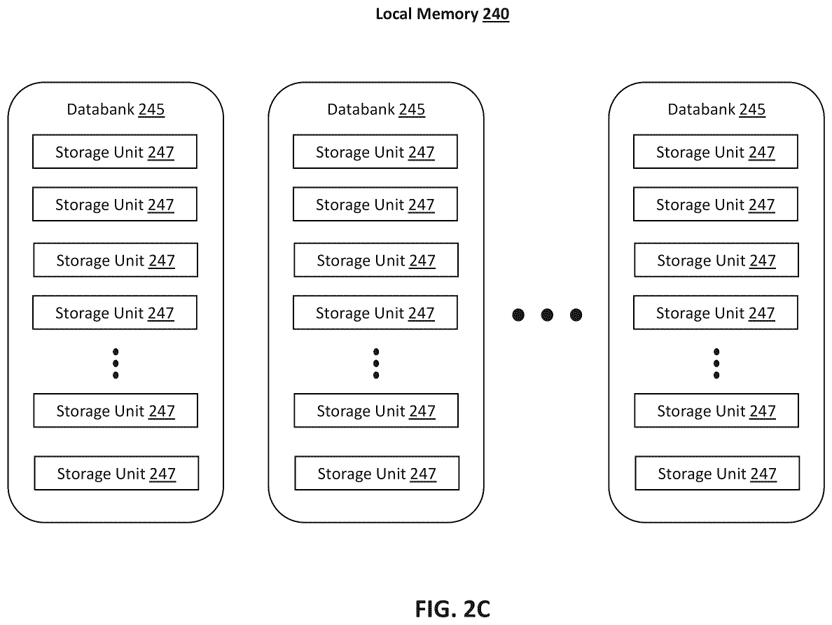

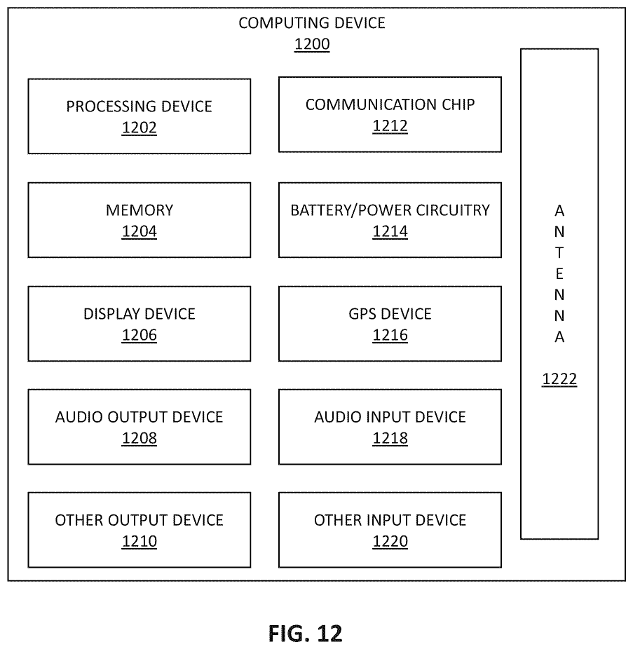

FIG. 2A is a block diagram of a DNN system 200, in accordance with various embodiments. The whole DNN system 200 or a part of the DNN system 200 may be implemented in one or more computing devices, such as the computing device 1200 in FIG. 12. The DNN system 200 can generate and execute DNNs, such as the DNN 100 in FIG. 1. As shown in FIG. 2A, the DNN system 200 includes a DNN module 201 and a DNN accelerator 202. In other embodiments, alternative configurations, different or additional components may be included in the DNN system 200. For instance, the DNN system 200 may include multiple DNN modules or multiple DNN accelerators. Further, functionality attributed to a component of the DNN system 200 may be accomplished by a different component included in the DNN system 200 or a different system. In some embodiments, the DNN module 201 and DNN accelerator 202 may include different types of processing units. The DNN module 201 and DNN accelerator 202 may be implemented in the same chip or separate chips.

The DNN module 201 facilitates generation and application of DNNs. In some embodiments, the DNN module 201 may generate and train DNNs. For instance, the DNN module 201 can define the layered architecture of a DNN. The DNN module 201 can also determine the internal parameters (e.g., weights) of the DNN through a DNN training process. The DNN module 201 may also determine one or more hyperparameters that define how the DNN is trained or how one or more deep learning operations in the DNN are to be performed. For instance, hyperparameters may indicate how convolutions or convolutions variants in the DNN are to be performed. Examples of the hyperparameters may include padding size, stride size, kernel size, dilation rate, and so on.

In some embodiments, the DNN module 201 generates sparsity maps to facilitate computations in convolutions variants in DNNs. For instance, the DNN module 201 may generate a sparsity map for a convolution variant, such as transposed convolution, resized convolution, dilated convolution, and so on. The convolution variant may include expanding the tensor by inserting zeros at various locations in the tensor. The result of the expansion may be referred to as an upsampled tensor. The upsampled tensor includes the data elements (e.g., activations or weights) in the tensor and the inserted zeros. The sparsity map may include elements, each of which corresponds to a data element in the upsampled tensor and indicates whether the data element is from the tensor or is a zero.

The DNN module 201 may generate a sparsity map based on one or more hyperparameters of the convolution variant. The one or more hyperparameters may indicate the locations of the zeros in the upsampled tensor. The one or more hyperparameters may include kernel size, padding size, stride size, dilation rate, other hyperparameters, or some combination thereof.

With the sparsity map, the convolution variant may be performed without storing the zeros, which can reduce memory footprint. The data elements of the tensor, which will be processed to compute the output of the convolution variant may be stored. The DNN module 201 may also generate storage pointers that can be used to read the data elements of the tensor from the memory (or memories). A storage pointer may point to a storage unit (also referred to as “storage element”) in a memory. For instance, the storage pointer may include information that indicates one or more memory addresses associated with the storage unit. The storage unit may store one or more data elements of the tensor. In some embodiments, the storage pointer corresponds to a sparsity map and the one or more data elements stored in the storage unit of the storage pointer may correspond to one or more elements of the sparsity map.

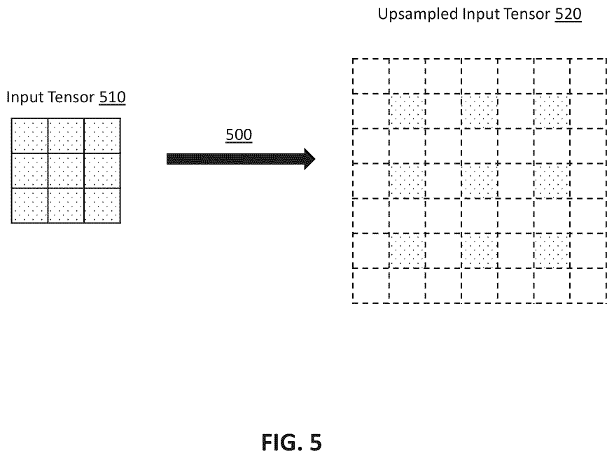

The DNN module 201 may further deploy trained or validated DNNs for use in deep learning applications. In some embodiments, the DNN module 201 may distribute trained or validated DNNs to devices or systems which may use the DNNs to perform tasks (e.g., image classification, motion planning, etc.) for which the DNNs were trained. In other embodiments, the DNN module 201 may facilitate deployment of the DNNs using the DNN accelerator 202. For instance, the DNN module 201 may receive data from a device or system coupled with the DNN system 200 and input the received data (or data generated by the DNN module 201, e.g., based on the received data) into a DNN. The DNN module 201 may generate instructions (e.g., configuration files) that control the operation of the DNN accelerator 202 during the DNN inference, The DNN module 201 may receive an output of the DNN from the DNN accelerator 202. The DNN module 201 may transmit the output of the DNN (or a result of processing the output of the DNN by the DNN module 201) to the device or system. Certain aspects of the DNN module 201 are provided below in conjunction with FIG. 5.

The DNN accelerator 202 executes DNNs provided by the DNN module 201. For instance, the DNN accelerator 202 can perform DNN inference, e.g., by running deep learning operations in the DNNs, for training DNNs or for using the trained or validated DNNs to perform tasks. As shown in FIG. 2, the DNN accelerator 202 includes a memory 210, a DMA engine 220, and compute block 230 (individually referred to as “compute block 230”). In other embodiments, alternative configurations, different or additional components may be included in the DNN accelerator 202. For example, the DNN accelerator 202 may include more than one memory 210 or DMA engine 220. As another example, the DNN accelerator 202 may include a single compute block 230. Further, functionality attributed to a component of the DNN accelerator 202 may be accomplished by a different component included in the DNN accelerator 202 or by a different system. A component of the DNN accelerator 202 may be implemented in hardware, software, firmware, or some combination thereof.

The memory 210 stores data associated with deep learning operations (including activation functions) performed by the DNN accelerator. In some embodiments, the memory 210 may store data to be used by the compute blocks 230 for DNN inference. For example, the memory 210 may store data computed by the precompute module 205, such as coefficients of Taylor series. As another example, the memory 210 may store weights, such as weights of convolutional layers, which are determined by training DNNs. The memory 210 may also store data generated by the compute blocks 230 from performing deep learning operations in DNNs. Example deep learning operations include convolutions (also referred to as “convolutional operations”), pooling operations, elementwise operations, activation functions, other types of deep learning operations, or some combination thereof. The memory 210 may be a main memory of the DNN accelerator 202. In some embodiments, the memory 210 includes one or more DRAMs (dynamic random-access memory).

The DMA engine 220 facilitates data transfer between the memory 210 and local memories of the compute blocks 230. For example, the DMA engine 220 can read data from the memory 210 and write data into a local memory of a compute block 230. As another example, the DMA engine 220 can read data from a local memory of a compute block 230 and write data into the memory 210. The DMA engine 220 provides a DMA feature that allows the compute block 230 to initiate data transfer between the memory 210 and the local memories of the compute blocks 230 and to perform other operations while the data transfer is in being conducted. In some embodiments, the DMA engine 220 may read tensors from the memory 210, modify the tensors in a way that is optimized for the compute block 230 before it writes the tensors into the local memories of the compute blocks 230.

The compute blocks 230 can perform deep learning operations in DNNs, including convolution and convolution variants. For instance, a compute block 230 may run a deep learning operation in a DNN layer, or a portion of the deep learning operation, at a time. The compute blocks 230 may be capable of running various types of deep learning operations, such as convolution, pooling, elementwise operation, linear operation, nonlinear operation, and so on. In an example, a compute block 230 may perform convolutions, e.g., standard convolution or depthwise convolution. In some embodiments, the compute block 230 receives an input tensor and one or more convolutional kernels and performs a convolution with the input tensor and convolutional kernels. The result of the convolution may be an output tensor, which can be further computed, e.g., by the compute block 230 or another compute block 230. In some embodiments, the operations of the DNN layers may be run by multiple compute blocks 230 in parallel. For instance, multiple compute blocks 230 may each perform a portion of a workload for a convolution. Data may be shared between the compute blocks 230. A compute block 230 may also be referred to as a compute tile. In some embodiments, each compute block 230 may be a processing unit.

In the embodiments of FIG. 2, each compute block 230 includes a local memory 240, a PE array 250, a data distributor 260, a sparsity accelerator 270, and a post processing unit 280. Some or all the components of the compute block 230 can be implemented on the same chip. In other embodiments, alternative configurations, different or additional components may be included in the compute block 230. Further, functionality attributed to a component of the compute block 230 may be accomplished by a different component included in the compute block 230, a different compute block 230, another component of the DNN accelerator 202, or a different system. A component of the compute block 230 may be implemented in hardware, software, firmware, or some combination thereof.

The local memory 240 is local to the corresponding compute block 230. In the embodiments of FIG. 2, the local memory 240 is inside the compute block 230. In other embodiments, the local memory 240 may be outside the compute block 230. The local memory 240 may store data received, used, or generated by the PE array 250 and the post processing unit 280. Examples of the data may include input activations, weights, output activations, coefficients of Taylor series, results of activation functions, sparsity bitmaps, and so on. Data in the local memory 240 may be transferred to or from the memory 210, e.g., through the DMA engine 220. In some embodiments, data in the local memory 240 may be transferred to or from the local memory of another compute block 230.

In some embodiments, the local memory 240 is one or more static random-access memories (SRAMs). The local memory 240 may be byte-addressable, and each memory address identifies a single byte (eight bits) of storage. In some embodiments, the local memory 240 may include databanks. The number of databanks in the local memory 240 may be 16, 64, 128, 256, 512, 1024, 2048, or other numbers. A databank may include a plurality of storage units. In an example, a databank may include 8, 16, 64, or a different number of storage units. A databank or a storage unit may have one or more memory addresses. In an example, a storage unit may store a single byte, and data larger than a single byte may be stored in storage units with consecutive memory addresses, i.e., adjacent storage units. For instance, a storage unit can store an integer number in the INT8 format, versus two storage units may be needed to store a number in the FP16 or BF16 format, which has 16 bits. In some embodiments, 16 bits can be transferred from the local memory 240 in a single read cycle. In other embodiments, 16 bits can be transferred from the local memory 240 in multiple read cycles, such as two cycles. Certain aspects the local memory 240 are described below in conjunction with FIG. 2C.

The PE array 250 may include PEs arranged in columns, or columns and rows. Each PE can perform MAC operations. In some embodiments, a PE includes one or more multipliers for performing multiplications. An PE may also include one or more accumulators (“adders”) for performing accumulations. A column of PEs is referred to as a PE column. A PE column may be associated with one or more MAC lanes. A MAC lane is a path for loading data into a MAC column. A MAC lane may be also referred to as a data transmission lane or data loading lane. A PE column may have multiple MAC lanes. The loading bandwidth of the MAC column is an aggregation of the loading bandwidths of all the MAC lanes associated with the MAC column. With a certain number of MAC lanes, data can be fed into the same number of independent PEs simultaneously. In some embodiments where a MAC column has four MAC lanes for feeding activations or weights into the MAC column and each MAC lane may have a bandwidth of 16 bytes, the four MAC lanes can have a total loading bandwidth of 64 bytes.

In some embodiments, the PE array 250 may be capable of depthwise convolution, standard convolution, or both. In a depthwise convolution, a PE may perform an MAC operation that includes a sequence of multiplications for an input operand and a weight operand. Each multiplication in the sequence (also referred to as a cycle) is a multiplication of a different activation in the input operand with a different weight in the weight operand. The activation and weight in the same cycle may correspond to the same channel. The sequence of multiplication produces a product operand that includes a sequence of products. The MAC operation may also include accumulations in which multiple product operands are accumulated to produce an output operand of the PE. The PE array 250 may output multiple output operands at a time, each of which is generated by a different PE. In a standard convolution, MAC operations may include accumulations across the channels. For instance, as opposed to generating an output operand, a PE may accumulate products across different channels to generate a single output point.

In some embodiments, the PE array 250 may perform MAC operations in quantized inference, such as MAC operations in a quantized convolution. In some embodiments, a PE in the PE array 250 may receive quantized activation and quantized weights and compute a quantized MAC result. The quantized MAC result may be a quantized value in an integer format and may be the output of the PE. In some embodiments, the PE may also include a quantization multiplier that can multiply a quantization scale with the quantized MAC result, and the output of the PE may be a real value in a floating-point format. The PE may include no quantization subtractors as zero-point offsetting is not needed for the MAC operations in quantized inference.

The data distributor 260 distributes data (e.g., input activations, weights, etc.) of deep learning operations to PEs in the PE array 250 for the PE array 250 to process the data to perform computations in the deep learning operations. The data may be stored in the local memory 240. In some embodiments, the data distributor 260 may be arranged on a data load path from the local memory 240 to the PE array 250.

In some embodiments, the data distributor 260 may distribute data of a deep learning operation to the PEs based on the structures of an input tenor (e.g., the input tensor 810) and one or more weight tensors (e.g., the filters 820) of the deep learning operation. For instance, the input tensor may include a plurality of input channels. A weight tensor may include weights in the input channels. In embodiments where the deep learning operation has multiple output channels (i.e., the output tensor (e.g., the output tensor 830) includes multiple channels), there would be multiple weight tensors, each of which is for one of the output channels. The data distributor 260 may distribute the data based on output channels. In an embodiment, the data distributor 260 may distribute the weight tensors to different PE columns. For instance, each PE column may receive a different weight tensor from the other PE columns. Each of the PE columns may receive the input tensor and perform MAC operations on the input tensor and the corresponding weight tensor.

For a single PE column, the data distributor 260 may partition the input tensor into input operands and partition the weight tensor into weight operands. The data distributor 260 may distribute an input operand (aka “activation operand,” e.g., the input operand 817) and a corresponding weight operand (e.g., the weight operand 827) to a PE in the PE column. The PE may perform a MAC operation on the input operand and weight operand. The data distributor 260 may distribute different input operands/weight operands to the same PE in different computation cycles. In some embodiments, an input operand may include input activations having the same (X, Y) coordinates but in different input channels. Similarly, a weight operand may include input weights having the same (X, Y) coordinates but in different input channels. In an example, an activation in the input operand may be in a different input channel from all the other activations in the input operand, and a weight in the weight operand may be in a different input channel from all the other weights in the weight operand.

The sparsity accelerator 270 accelerates computations in the PE array 250 based on sparsity in activations or weights. For instance, the sparsity accelerator 270 may use sparsity maps generated by the DNN module 201 to accelerate computations in convolution variants. In some embodiments, a computation in a PE may be a MAC operation on an input operand and a weight operand. The input operand may include one or more activations, e.g., activations in an input tensor of a convolution or activations in an upsampled tensor of a convolution variant. Different activations may be in different input channels. The weight operand may include one or more weights, e.g., weights in a filter of a convolution or weights in a dilated filter of a convolution variant. The weights in the weight operand may be in different input channels.

In some embodiments, the input operand is associated with an activation bitmap, which may be stored in the local memory 240. The activation bitmap can indicate positions of the zero-valued activations in the input operand. In an embodiment for performing a transposed or resized convolution, the activation bitmap may indicate positions where zeros are inserted into the input tensor of the transposed or resized convolution. The activation bitmap may include a plurality of bits, each of which corresponds to a respective activation in the input operand. The position of a bit in the activation bitmap may match the position of the corresponding activation in the input operand. A bit in the activation bitmap may be zero or one. A zero-valued bit indicates that the corresponding activation is a zero inserted into the input tensor of the transposed or resized convolution, a one-valued bit indicates that the corresponding activation is an activation in the input tensor of the transposed or resized convolution. An activation bitmap may be a sparsity map generated by the DNN module 201.

In some embodiments, the weight operand is associated with a weight bitmap, which may be stored in the local memory 240. The weight bitmap can indicate positions of the zero-valued weights in the weight operand. In an embodiment for performing a dilated convolution, the weight bitmap may indicate positions where zeros are inserted into the filter of the dilated convolution. The weight bitmap may include a plurality of bits, each of which corresponds to a respective weight in the weight operand. The position of a bit in the weight bitmap may match the position of the corresponding weight in the weight operand. A bit in the weight bitmap may be zero or one. A zero-valued bit indicates that the corresponding weight is a zero inserted into the filter of the dilated convolution to dilate the filter, a one-valued bit indicates that the corresponding weight is a weight in the original filter of the dilated convolution. A weight bitmap may be a sparsity map generated by the DNN module 201.

In some embodiments, the sparsity accelerator 270 may receive the activation bitmap and the weight bitmap and generate a combined sparsity bitmap for the MAC operation to be performed by the PE. In some embodiments, the sparsity accelerator 270 generates the combined sparsity bitmap 735 by performing one or more AND operations on the activation bitmap and the weight bitmap. Each bit in the combined sparsity bitmap is a result of an AND operation on a bit in the activation bitmap and a bit in the weight bitmap, i.e., a product of the bit in the activation bitmap and the bit in the weight bitmap. The position of the bit in the combined sparsity bitmap matches the position of the bit in the activation bitmap and the position of the bit in the weight bitmap. A bit in the combined bitmap corresponds to a pair of activation and weight (activation-weight pair). A zero bit in the combined sparsity bitmap indicates that at least one of the activation and weight was added to the original input tensor or filter for expanding the original input tensor or filter. A one bit in the combined sparsity bitmap indicates that the activation is in the original input tensor and the weight is in the original filter. The combined sparsity bitmap may be stored in the local memory 240.

The sparsity accelerator 270 may provide activations and weights to the PE based on the combined sparsity bitmap. For instance, the sparsity accelerator 270 may identify one or more activation-weight pairs from the local memory 240, each of which corresponds to a one-valued bit in the combined sparsity bitmap. The local memory 240 may store input operands and weight operands in a compressed format so that identified activation-weight pairs are stored but other activation-weight pairs (e.g., one or more activation-weight pairs, each of which corresponds to a zero-valued bit in the combined sparsity bitmap) are not stored.

The identified activation(s) of an input operand may constitute a compressed input operand. The identified weight(s) of a weight operand may constitute a compressed weight operand. The compressed input operand and compressed weight operand may be stored in the local memory 240. In some embodiments, the identified activation(s) and identified weight(s) can be read from the local memory 240 based on the sparsity bitmaps (e.g., the activation bitmap, weight bitmap, the combined bitmap, or some combination thereof) and storage pointers generated by the DNN module 201. A storage pointer may indicate the location where a compressed input operand or a compressed weight operand is stored in the local memory 240. For an identified activation-weight pair, the sparsity accelerator 270 may determine a position the activation in the compressed input operand and determine a position of the weight in the compressed weight operand based on the activation bitmap, weight bitmap, and the combined bitmap. The activation and weight can be read from the local memory 240 based on the positions determined by the sparsity accelerator 270 and the corresponding storage pointer.

The sparsity accelerator 270 may be implemented in hardware, software, firmware, or some combination thereof. In some embodiments, at least part of the sparsity accelerator 270 may be inside a PE. Even though FIG. 4 shows a single sparsity accelerator 270, the compute block 230 may include multiple sparsity modules 450. In some embodiments, every PE in the PE array 250 is implemented with a sparsity accelerator 270 for accelerating computation and reducing power consumption in the individual PE. In other embodiments, a subset of the PE array 250 (e.g., a PE column or multiple PE columns in the PE array 250) may be implemented with a sparsity accelerator 270 for acceleration computations in the subset of PEs.

The post processing unit 280 processes outputs of the PE array 250. In some embodiments, the post processing unit 280 computes activation functions. The post processing unit 280 may receive outputs of the PE array 250 as inputs to the activation functions. The post processing unit 280 may transmit the outputs of the activation functions to the local memory 240. The outputs of the activation functions may be retrieved later by the PE array 250 from the local memory 240 for further computation. For instance, the post processing unit 280 may receive an output tensor of a DNN layer from the PE array 250 and computes one or more activation functions on the output tensor. The results of the computation by the post processing unit 280 may be stored in the local memory 240 and later used as input tensor of the next DNN layer. In addition to or alternative to activation functions, the post processing unit 280 may perform other types of post processing on outputs of the PE array 250. For instance, the post processing unit 280 may apply a bias on an output of the PE array 250.

In some embodiments, the local memory 240 is associated with a load path and a drain path may be used for data transfer within the compute block 230. For instance, data may be transferred from the local memory 240 to the PE array 250 through the load path. Data may be transferred from the PE array 250 to the local memory 240 through the drain path. The data distributor 260 may be arranged on the load path. The post processing unit 280 may be arranged on the drain path for processing outputs of the PE array before the data is written into the local memory 240.

FIG. 2B is a block diagram of the DNN module 201, in accordance with various embodiments. In the embodiments of FIG. 2B, the DNN module 201 includes an interface module 211, a training module 221, a validating module 231, a convolution variant module 241, and a datastore 251. In other embodiments, alternative configurations, different or additional components may be included in the DNN module 201. Further, functionality attributed to a component of the DNN module 201 may be accomplished by a different component included in the DNN module 201 or a different module or system, such as the DNN accelerator 202.

The interface module 211 facilitates communications of the DNN module 201 with other modules or systems. For example, the interface module 211 establishes communications between the DNN module 201 with an external database to receive data that can be used to train DNNs or input into DNNs to perform tasks. As another example, the interface module 211 supports the DNN module 201 to distribute DNNs to other systems, e.g., computing devices configured to apply DNNs to perform tasks.

The training module 221 trains DNNs by using a training dataset. The training module 221 forms the training dataset. In an embodiment where the training module 221 trains an DNN to recognize objects in images, the training dataset includes training images and training labels. The training labels describe ground-truth classifications of objects in the training images. In some embodiments, each label in the training dataset corresponds to an object in a training image. In some embodiments, a part of the training dataset may be used to initially train the DNN, and the rest of the training dataset may be held back as a validation subset used by the validating module 231 to validate performance of a trained DNN. The portion of the training dataset not including the tuning subset and the validation subset may be used to train the DNN.

The training module 221 also determines hyperparameters for training the DNN. Hyperparameters are variables specifying the DNN training process. Hyperparameters are different from parameters inside the DNN (e.g., weights of filters). In some embodiments, hyperparameters include variables determining the architecture of the DNN, such as number of hidden layers, etc. Hyperparameters also include variables which determine how the DNN is trained, such as batch size, number of epochs, etc. A batch size defines the number of training samples to work through before updating the parameters of the DNN. The batch size is the same as or smaller than the number of samples in the training dataset. The training dataset can be divided into one or more batches. The number of epochs defines how many times the entire training dataset is passed forward and backwards through the entire network. The number of epochs defines the number of times that the deep learning algorithm works through the entire training dataset. One epoch means that each training sample in the training dataset has had an opportunity to update the parameters inside the DNN. An epoch may include one or more batches. The number of epochs may be 3, 30, 300, 300, or even larger.

The training module 221 defines the architecture of the DNN, e.g., based on some of the hyperparameters. The architecture of the DNN includes an input layer, an output layer, and a plurality of hidden layers. The input layer of an DNN may include tensors (e.g., a multidimensional array) specifying attributes of the input image, such as the height of the input image, the width of the input image, and the depth of the input image (e.g., the number of bits specifying the color of a pixel in the input image). The output layer includes labels of objects in the input layer. The hidden layers are layers between the input layer and output layer. The hidden layers include one or more convolutional layers and one or more other types of layers, such as pooling layers, fully connected layers, normalization layers, softmax or logistic layers, and so on. The convolutional layers of the DNN abstract the input image to a feature map that is represented by a tensor specifying the feature map height, the feature map width, and the feature map channels (e.g., red, green, blue images include 3 channels). A pooling layer is used to reduce the spatial volume of input image after convolution. It is used between 2 convolution layers. A fully connected layer involves weights, biases, and neurons. It connects neurons in one layer to neurons in another layer. It is used to classify images between different categories by training.

In the process of defining the architecture of the DNN, the training module 221 also adds an activation function to a hidden layer or the output layer. An activation function of a layer transforms the weighted sum of the input of the layer to an output of the layer. The activation function may be, for example, a rectified linear unit activation function, a tangent activation function, or other types of activation functions.

After the training module 221 defines the architecture of the DNN, the training module 221 inputs a training dataset into the DNN. The training dataset includes a plurality of training samples. An example of a training sample includes an object in an image and a ground-truth label of the object. The training module 221 modifies the parameters inside the DNN (“internal parameters of the DNN”) to minimize the error between labels of the training objects that are generated by the DNN and the ground-truth labels of the objects. The internal parameters include weights of filters in the convolutional layers of the DNN. In some embodiments, the training module 221 uses a cost function to minimize the error.

The training module 221 may train the DNN for a predetermined number of epochs. The number of epochs is a hyperparameter that defines the number of times that the deep learning algorithm will work through the entire training dataset. One epoch means that each sample in the training dataset has had an opportunity to update internal parameters of the DNN. After the training module 221 finishes the predetermined number of epochs, the training module 221 may stop updating the parameters in the DNN. The DNN having the updated parameters is referred to as a trained DNN.

The validating module 231 verifies accuracy of trained or compressed DNNs. In some embodiments, the validating module 231 inputs samples in a validation dataset into a trained DNN and uses the outputs of the DNN to determine the model accuracy. In some embodiments, a validation dataset may be formed of some or all the samples in the training dataset. Additionally or alternatively, the validation dataset includes additional samples, other than those in the training sets. In some embodiments, the validating module 231 may determine an accuracy score measuring the precision, recall, or a combination of precision and recall of the DNN. The validating module 231 may use the following metrics to determine the accuracy score: Precision=TP/(TP+FP) and Recall=TP/(TP+FN), where precision may be how many the reference classification model correctly predicted (TP or true positives) out of the total it predicted (TP+FP or false positives), and recall may be how many the reference classification model correctly predicted (TP) out of the total number of objects that did have the property in question (TP+FN or false negatives). The F-score (F-score=2*PR/(P+R)) unifies precision and recall into a single measure.

The validating module 231 may compare the accuracy score with a threshold score. In an example where the validating module 231 determines that the accuracy score of the augmented model is less than the threshold score, the validating module 231 instructs the training module 221 to re-train the DNN. In one embodiment, the training module 221 may iteratively re-train the DNN until the occurrence of a stopping condition, such as the accuracy measurement indication that the DNN may be sufficiently accurate, or a number of training rounds having taken place.

The convolution variant module 241 facilities performance of convolution variants based on sparsity maps and storage pointers. In the embodiments of FIG. 2B, the convolution variant module 241 includes a tensor expansion analyzer 261, a sparsity map generator 271, and a storage pointer generator 281. In other embodiments, alternative configurations, different or additional components may be included in the convolution variant module 241. Further, functionality attributed to a component of the convolution variant module 241 may be accomplished by a different component included in the convolution variant module 241, the DNN module 201, or a different module or system, such as the DNN accelerator 202.

The tensor expansion analyzer 261 analyzes tensor expansions in convolution variants. In some embodiments, the tensor expansion analyzer 261 may analyze tensor expansion in a convolution variant based on one or more hyperparameters of the convolution variant. For instance, the tensor expansion analyzer 261 may use the one or more hyperparameters to determine how many zeros are to be inserted into the tensor of the convolution variant for the expansion and where in the tensor the zeros are to be inserted.

In embodiments where the convolution variant is a transposed convolution, the tensor expansion analyzer 261 may determine how many zeros are to be inserted into the input tensor and where in the input tensor the zeros are to be inserted based on the kernel size, stride size, and padding size of the transposed convolution. For instance, the tensor expansion analyzer 261 may determine that z=s−1 zeros are to be inserted between any two neighboring rows and between any two neighboring columns of the input tensor, where s denotes the stride size of the transposed convolution. The stride size may indicate the number of activations the kernel jumps over when sliding across the input tensor. may be an integer, such as 1, 2, and so on. The tensor expansion analyzer 261 may also determine that p′=k−p−1 zeros between the rows of columns of the input tensor, where k denotes the kernel size of the transposed convolution, and p denotes the padding size of the transposed convolution. The kernel size may be an integer and may equal the height or weights of the kernel (or filter) of the transposed convolution. The padding size may be an integer, such as 1, 2, and so on.

In an embodiment where the input tensor has a size of H×W×C, the upsampled tensor, which is generated by expanding the input tensor, may have a size of [H+(H−1)×(s−1)+2×(k−p−1)]×[W+(W−1)×(s−1)+2×(k−p−1)]×C, where H denotes the height of the input tensor (e.g., the number of rows in the input tensor or the number of data elements in a row), W denotes the weights of the input tensor (e.g., the number of columns in the input tensor or the number of data elements in a row), and C denotes the depth of the input tensor (e.g., the number of input channels).

In embodiments where the convolution variant is a dilated convolution, the tensor expansion analyzer 261 may determine how many zeros are to be inserted into a kernel of the dilated convolution and where in the kernel the zeros are to be inserted based on the dilation rate of the dilated convolution. For instance, the tensor expansion analyzer 261 may determine that z=D−1 zeros are to be inserted between any two neighboring rows and between any two neighboring columns of the kernel, where D denotes the dilation rate. The dilation rate indicates how many gaps are between any two neighboring rows and any two neighboring columns. In some embodiments, all the weights in the kernel are matched not to adjacent activations in the input tensor, but to those that are adjacent separated by D along H or W direction of the input tensor. The dilation rate may be an integer, such as 1, 2, and so on.

The sparsity map generator 271 generates sparsity maps based on analysis done by the tensor expansion analyzer 261. A sparsity map may correspond to an upsampled tensor (or a portion of an upsampled) of a convolution variant. The sparsity map may itself be a tensor (e.g., matrix, vectors, etc.) including a plurality of elements. An element in the sparsity map may indicate whether a data element in the upsampled tensor is in the original tensor, which is expanded to generate the upsampled tensor, or is a zero inserted into the original tensor for generating the upsampled tensor. In some embodiments, each element in a sparsity map may be a bit, and the sparsity map may be referred to as a sparsity bitmap.

In some embodiments, the sparsity map generator 271 may generate a sparsity map for an operand to be processed by a PE (or multiple PEs) in a computation cycle. The PE(s) may perform an MAC operation on the operand. For instance, a sparsity map may correspond to a vector in the tensor that has a size of 1×1×N, where N denotes the number of data elements in the vector. N may be a multiple of an integer, such as 4, 8, 16, 32, and so on. The sparsity map may include N elements, each of which corresponds to a different data element in the vector. The position of an element of the sparsity map in the sparsity map may match the position of the corresponding data element in the vector. The data elements in the vector may be in different input channels of the convolution variant.

The storage pointer generator 281 generates storage pointers for data elements in tensors of convolution variants. In some embodiments, a storage pointer may indicate one or more memory addresses where one or more data elements are stored. For instance, a storage pointer may include or store information of the one or more memory addresses. A storage pointer may be associated with an operand to be processed by a PE. The data elements in the operand may be read from the memory using the storage pointer and transferred to the PE for computation. The storage pointer generator 281 may generate multiple storage pointers for a single tensor. In some embodiments, the storage pointer generator 281 may generate a storage pointer table for a tensor. The storage pointer table includes a plurality of storage pointers, each of which may indicate the storage location of a vector in the tensor. In an example, the vector may have a size of 1×1×N, where N denotes the number of data elements in the vector. N may be a multiple of an integer, such as 4, 8, 16, 32, and so on. For a tensor having a size of H×W×C, the storage pointer table may include H×W storage pointers. Each of the storage pointers indicates locations where 1×1×C data elements in the tensor are stored.

Convolution variants may be performed based on sparsity maps and storage pointers. In some embodiments, a convolution variant may be converted to one or more convolutions, and the convolutions may be performed based on the sparsity maps and storage pointers generated for the convolution variant. The output of the convolution(s) would be the output of the convolution variant.

As an example, a transposed convolution may be performed as a convolution having the upsampled tensor as its input tensor, the kernel of the transposed convolution as its kernel, and a stride size of 1. For instance, a transposed convolution with stride size s=2, kernel size k=2 and padding size p=0 (i.e., no padding) can be converted to a regular convolution with stride size s′=1, kernel size k′=2 and padding size p=k′−1 on an input tensor with a size of [H+(H−1)×(s−1)]×[W+(W−1)×(s−1)]×C.

As another example, a dilated convolution may be decomposed to a plurality of convolutions. The number of convolutions for a dilated convolution may depend on the dilation rate D. For instance, the number of convolutions may equal D². The size of the input tensor of the dilated convolution may be D² times the size of the input tensor of each convolution. To perform each convolution, the corresponding activations may be identified and read from the local memory 240 based on one or more storage pointers indicating the locations where the activations are stored in the local memory 240. In some embodiments, the dilated convolution may have one or more dummy sparsity maps, which may be generated by the DNN module 201, that can be shared among the D² convolutions. All the elements of a dummy sparsity map may be ones so that no activations in the input tensor would be skipped from the MAC operations in the convolutions.

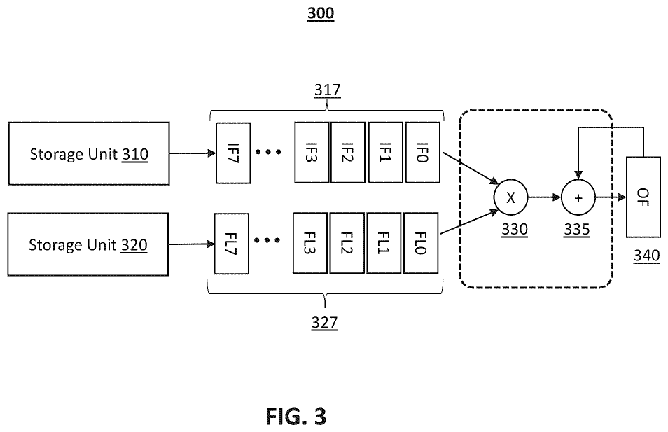

The datastore 251 stores data received, generated, used, or otherwise associated with the DNN module 201. For example, the datastore 251 stores the datasets used by the training module 221 and validating module 231. The datastore 251 may also store data generated by the training module 221 and validating module 231, such as the hyperparameters for training DNNs, internal parameters of trained DNNs (e.g., weights, etc.), data for sparsity acceleration (e.g., sparsity bitmap, etc.), and so on. In the embodiment of FIG. 3, the datastore 251 is a component of the DNN module 201. In other embodiments, the datastore 251 may be external to the DNN module 201 and communicate with the DNN module 201 through a network.

FIG. 2C illustrates the local memory 240, in accordance with various embodiments. The local memory 240 includes a plurality of databanks 245 (individually referred to as “databank 245”). Each databank 245 includes a plurality of storage units 247 (individually referred to as “storage unit 247”). The number of databanks 245 or storage units 247 in the local memory 240 may vary in different embodiments. In an example, the local memory 240 may include four databanks 245. A databank 245 may include 16 storage unit 247. In other embodiments, the local memory 240 may include a different number of databanks 245. Also, a databank 245 may include a different number of storage units 247.

In some embodiments, a databank 245 may store operands to be processed by a PE column. For instance, the PE column may perform MAC operations on the operands. In some embodiments, for a single databank 245, the number of storage units 247 may equal the number of PEs in the corresponding PE column. A storage unit 247 may store an operand to be processed by a single PE. The operands may be read in an order, e.g., the order the storage units 247 are arranged in the databank 245.

A storage unit 247 may be accessed individually. In some embodiments, a storage unit 247 stores a single operand at a time. The storage unit 247 may also store a sparsity map for the operand, based on which sparsity decoding may be performed before transferring the operand to the PE. In other embodiments, a storage unit 247 may store a portion of an operand or multiple operands. In embodiments where a storage unit 247 stores a portion of an operand, the storage unit 247 may store a sparsity map for the whole operand. Alternatively, the storage unit 247 does not store the sparsity map and the sparsity map of the operand is stored in another storage unit 247 that stores another portion of the operand. In embodiments where a storage unit 247 stores multiple operands, the storage unit may store the sparsity bitmap for all the operands.

A storage unit 247 may be associated with a storage pointer. The storage pointer may indicate a location of the storage unit 247 in the local memory 240 and may be used to read the operand stored in the storage unit 247. In some embodiments, a storage unit 247 may be a buffer, such as a circular buffer. A storage unit 247 may have a storage limit, but different storage units 247 may have the same or different storage limits.

### Example MAC Operation Facilitated by Storage Pointer

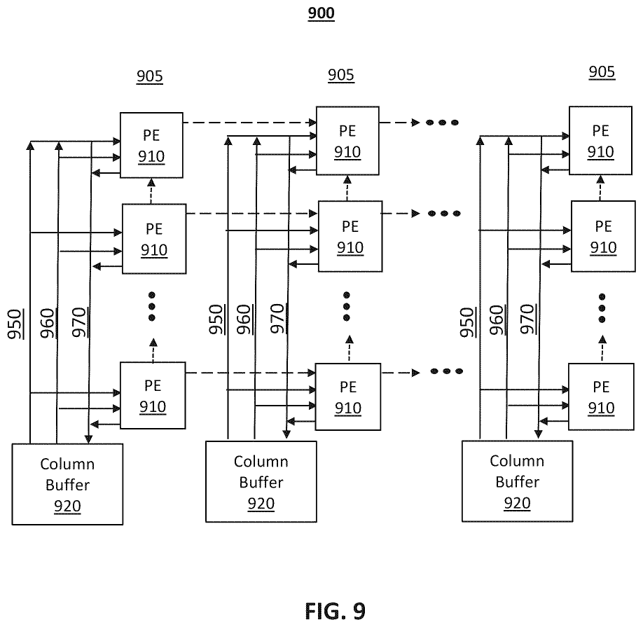

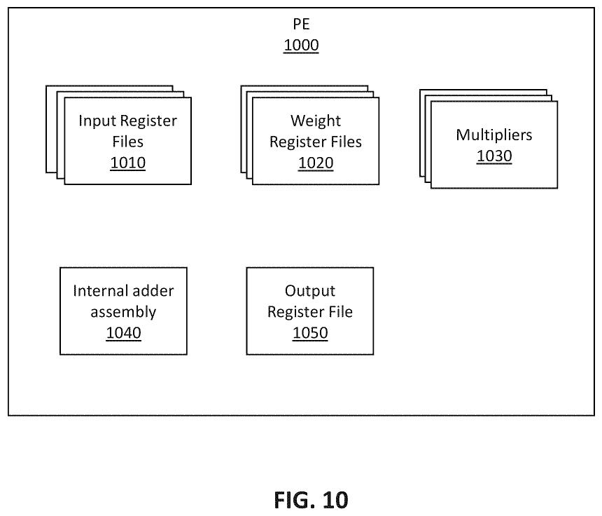

FIG. 3 illustrates an MAC operation 300 facilitated by storage pointers, in accordance with various embodiments. The MAC operation 300 may be part of a deep learning operation, such as a convolution or convolution variant. The MAC operation 300 may be performed on an activation operand (also referred to as “input operand”) including one or more activations and a weight operand including one or more weights. In the embodiments of FIG. 3, the MAC operation 300 is performed by a PE that includes an input register file 317, a weight register file 327, a multiplier 330, an accumulator 335, and an output register file 340. The PE may be an embodiment of a PE 910 in FIG. 9 or an embodiment of the PE 1000 in FIG. 10. In other embodiments, the PE may include fewer, more, or different components.

Before the MAC operation 300 is started, the storage unit 310 and storage unit 320 may be identified based on storage pointers associated with the activation operand and weight operand, respectively. The storage pointers may be generated by the DNN module 201, such as the storage pointer generator 281 in the convolution variant module 241. The activation operand is read from the storage unit 310 and transferred to the input register file 317. The weight operand is read from the storage unit 320 and transferred to the weight register file 327.

In the MAC operation 300, the activations stored in the input register file 317 and the weights stored in the weight register file 327 are fed sequentially into a multiplier 330, where the multiplier 330 performs a series of multiplication operations. Each multiplication operation is with an activation from the input register file 317 and a weight from the weight register file 327. In some embodiments, the activations or weights may be fed into the multiplier 330 based on a sparsity map, which may indicate positions of the activations or weights in an upsampled tensor, which may be generated by inserting zeros in the original tensor of the deep learning operation. The sparsity map may be used to determine which activation is to be multiplied with which weight, i.e., align the activation with the weight. The process of using the sparsity map to align activations and weights is referred to as sparsity decoding or sparsity alignment. The process may be performed before feeding the activation and weights to the multiplier 330.

The results of the multiplication operations are fed into an accumulator 335, which generates an individual partial sum of the MAC operation. The individual partial sum can be stored in the output register file 340. The series of multiplication operations by the multiplier 330 and the accumulation operation by the accumulator 335 may constitute the MAC operation 300. The individual partial sum may be further accumulated, e.g., by the accumulator 335, with a partial sum of another MAC operation.

### Example Convolution Variants

FIG. 4 illustrates a convolution 400 and a transposed convolution 405, in accordance with various embodiments. The convolution 400 may be a convolution in a convolutional layer of a DNN, e.g., a convolutional layer 110 in FIG. 1. The convolution 400 is executed on a tensor 410 and filters 420 (individually referred to as “filter 420”). The result of the convolution 400 is a tensor 430. The transposed convolution 405 is a reverse of the convolution 400. The input of the transposed convolution is the tensor 430, and the output of the transposed convolution is the tensor 410. For the purpose of simplicity and illustration, FIG. 4 shows the tensors 410 and 430 in an X-Y two-dimensional plane. The tensors 410 and 430 may be three-dimensional tensors. The tensors 410 and 430 may each include a plurality of channels. A depth of the tensor 410 or 430 in a direction perpendicular to the X-Y plane may be determined by the number of channels in the tensor 410 or 430.

The tensor 410 includes first activations arranged in a 2D array. A first activation is a data point in the tensor 410. Each first activation in the tensor 410 may be represented by an (X, Y) coordinate. The tensor 410 has a spatial size H₁×W₁, where H₁ is the height of the 3D matrix (i.e., the length along the Y axis, which indicates the number of first activations in a column in the 4D matrix of each input channel) and W₁ is the width of the 3D matrix (i.e., the length along the X-axis, which indicates the number of first activations in a row in the 4D matrix of each input channel). For the purpose of simplicity and illustration, the tensor 410 has a spatial size of 5×5.

The tensor 430 includes second activations arranged in a two-dimensional matrix. A second activation is a data point in the tensor 430. Each second activation in the tensor 430 may be represented by an (X, Y) coordinate. The tensor 430 has a spatial size H₂×W₂, where H₂ is the height of the two-dimensional matrix (i.e., the length along the Y axis, which indicates the number of second activations in a column in the two-dimensional matrix) and W₂ is the width of the two-dimensional matrix (i.e., the length along the X-axis, which indicates the number of second activations in a row in the two-dimensional matrix of each input channel). For the purpose of simplicity and illustration, the tensor 430 has a spatial size of 3×3, which is smaller than the size of the tensor 310.

The convolution 400 may be represented by a kernel size, a padding size, and a stride size. The kernel size indicates the layout of weights in the kernel. The kernel size may be represented as Hₖ×Wₖ, where Hₖ is the height of the kernel (i.e., the length along the Y axis, which indicates the number of weight in a column in the kernel) and Wₖ is the width of the kernel (i.e., the length along the X-axis, which indicates the number of weights in a row in the kernel). The padding size indicates the number of dummy activations to be added to the input of the convolution 400, e.g., the number of row(s) and column(s) of zeros to be added to the tensor 410. The stride size indicates the number of row(s) and column(s) traversed per slide during the convolution 400.

In the embodiments of FIG. 4, the kernel size is 3×3, the padding size is 1, and the stride size is 4. As shown in FIG. 4, the tensor 410 is converted to an upsampled tensor 415 through a padding process based on the padding size. A row of zeros is added to both the top and bottom edges of the tensor 410. A column of zeros is added to both the left and right edges of the tensor 410. The upsampled tensor 415 has a size of 7×7. Then the kernel slides across the upsampled tensor 415 with the stride size of 4. Each sliding step includes an MAC operation on an input operand and the kernel and results in an activation in the tensor 430. The input operand is a subtensor in the upsampled tensor 415 and has the same size as the kernel. For instance, in the first sliding step, an MAC operation may be performed on the kernel and a first input operand. The first input operand may include nine activations in the upsampled tensor 415, e.g., activations with (X, Y) coordinates including (0, 0), (0, 1), (0, 2), (1, 0), (1, 1), (1, 2), (2, 0), (2, 1), and (2, 2). The result of the MAC operation may be an activation (e.g., (0, 0)) in the tensor 430. In the second sliding step, another MAC operation may be performed on the kernel and a second input operand. The second input operand includes nine activations in the upsampled tensor 415. The (X, Y) coordinates of the activations in the second input operand may be (2, 0), (2, 1), (2, 2), (3, 0), (3, 1), (3, 2), (4, 0), (4, 1), and (4, 2). The result of this MAC operation may be another activation (e.g., (1, 0)) in the tensor 430. As all the sliding steps are finished, the tensor 430 is produced. The convolution 400 is a downsampling operation, as the tensor 430 is smaller than the tensor 410.

The transposed convolution 405 is the reverse of the convolution 400. The transposed convolution 405 is an upsampling operation, as the tensor 430 is the input and the tensor 410 is the output. The transposed convolution 405 may also be referred to as a transposed convolution or fractionally stride convolution since stride over the tensor 410 is equivalent to fractional stride over the tensor 430. For instance, a stride of 4 over the tensor 410 is ½ stride over the tensor 430. The transposed convolution 405 may also be represented by the kernel size, padding size, and stride size of the convolution 400.

The transposed convolution 405 may be executed as a new convolution, which may be different from the convolution 400. The new convolution has the tensor 410 as an output and a new tensor larger than the tensor 410 as an input. The new tensor may have a size larger than the tensor 410. The new tensor may be generated by padding the tensor 410.

FIG. 5 illustrates expansion of an input tensor 510, in accordance with various embodiments. In some embodiments, the expansion of the input tensor 510 may be for a resized convolution. In other embodiments, the expansion of the input tensor 510 may be for a transposed convolution, such as a 5×3s2p1 transposed convolution, i.e., the kernel size is 3×3, the stride size is 2, and the padding size is 1. An embodiment of the transposed convolution may be the transposed convolution 405 in FIG. 4. The input tensor 510 may be the input tensor of the resized or transposed convolution.

The input tensor 510 has a size of 3×3. Zeroed values are added to the input tensor 510 during the padding process 500 to generate an upsampled input tensor 520. The upsampled input tensor 520 may be generated through a padding process 500. The padding process 500 includes adding zeroed values to edges of the input tensor 510 based on a padding size. In some embodiments (e.g., embodiments where the input tensor 510 is an input tensor of a transposed convolution), the padding size may be determined based on the kernel size and the padding size of the transposed convolution. For instance, the padding size may be a result of the kernel size of the transposed convolution minus the padding size of the transposed convolution and further minus 1. In the embodiments of FIG. 5, the kernel size of the transposed convolution is 5 and the padding size of the transposed convolution is 1, so the padding size for the upsampling the input tensor is 1. Thus, one row of zeros is added to both the top and bottom edges of the tensor 410. Also, one column of zeros is added to both the left and right edges of the tensor 410.

The padding process also includes adding zeroed values between data elements in the input tensor 510. The number of zeroed values added between data elements in the input tensor 510 may equal s_{deconv}−1, where s_{deconv} is the stride size of the transposed convolution. In the embodiments of FIG. 5, s_{deconv}=2 so s_{deconv}−1=1. As shown in FIG. 5, one zeroed value is added between every two activations in the input tensor 510. The padding process produces a 7×7 tensor, i.e., the upsampled input tensor 520. For the purpose of illustration, the activations of the input tensor 510 are highlighted with a dotted pattern, and the zeroed values added to the input tensor 510 are not highlighted.

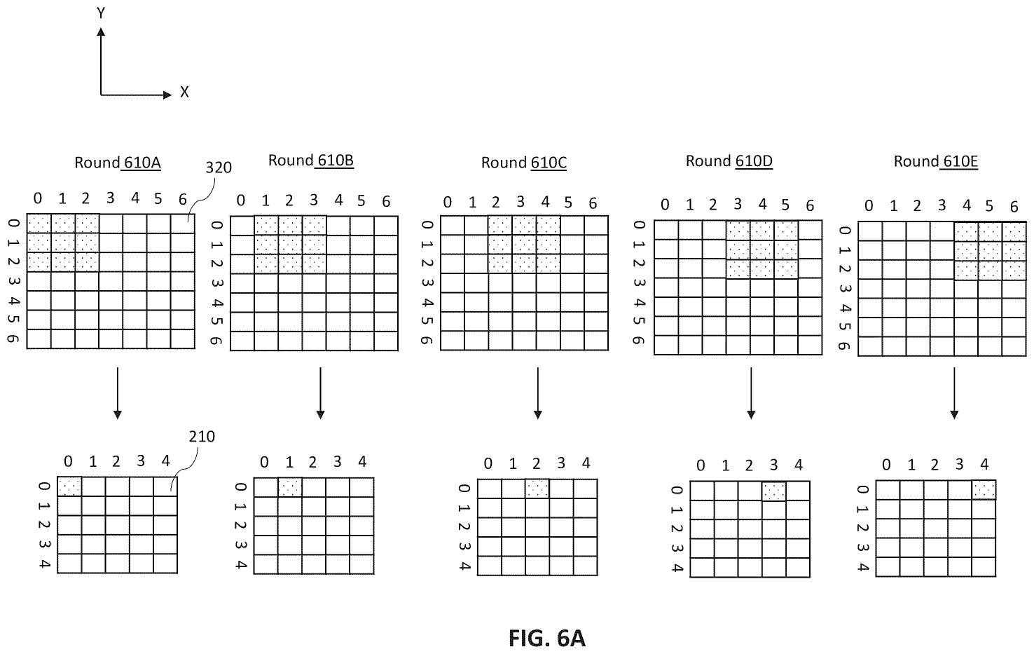

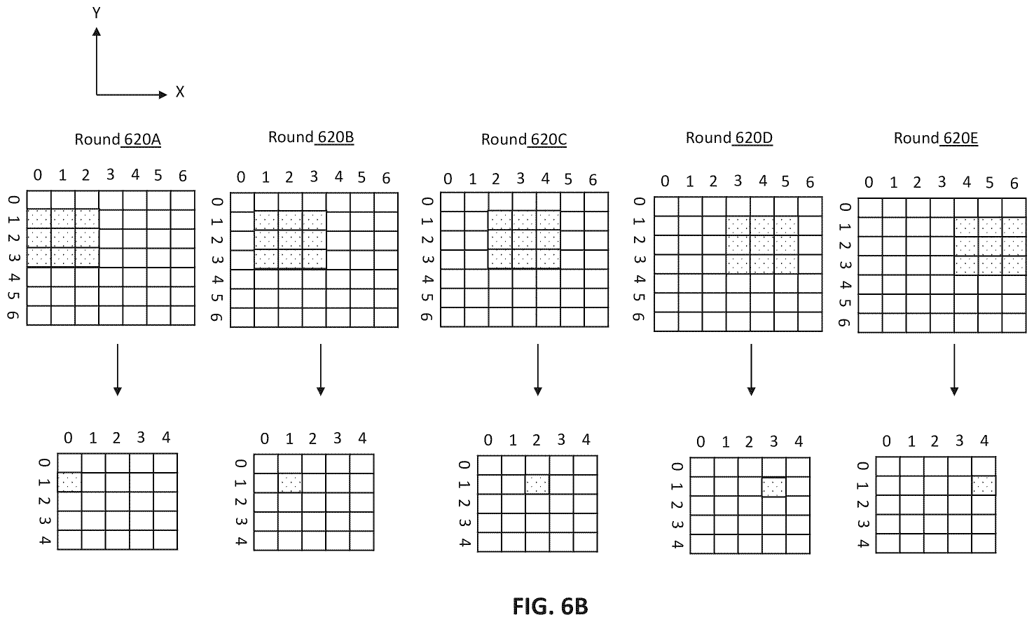

FIGS. 6A and 6B illustrate a transposed convolution converted to a convolution, in accordance with various embodiments. The transposed convolution may be a 3×3s2p1 transposed convolution. In the embodiments of FIGS. 6A and 6B, the transposed convolution is converted to a convolution having a 3×3 kernel and a stride size of 1. An example of the input tensor of the convolution may be the upsampled input tensor 520 in FIG. 5. An example of the output tensor of the convolution (i.e., the output tensor of the transposed convolution) is the tensor 410 in FIG. 4.

FIG. 6A shows that the kernel slides across the upsampled input tensor 520 along the X-axis in rounds 610A-410E (collectively referred to as “rounds 610” or “round 610”). Each round 610 includes an MAC operation of the kernel and a portion of the upsampled input tensor 520 that has the same size as the kernel. The result of the MAC operation is a data point in the first row of the tensor 410. As the stride size of the convolution is 1, the kernel moves over one column in the upsampled input tensor 520 after each round 610.

After the rounds 610, the kernel moves down along the Y axis. As the stride size is 1, the kernel moves down by one row in the upsampled input tensor 520. FIG. 6B shows that the kernel slides across the upsampled input tensor 520 along the X-axis in rounds 620A-420E (collectively referred to as “rounds 620” or “round 620”). Each round 620 includes an MAC operation of the kernel and a portion of the upsampled input tensor 520 that has the same size as the kernel. The result of the MAC operation is a data point in the second row of the tensor 410. As the stride size of the convolution is 1, the kernel moves over one column in the upsampled input tensor 520 after each round 620. Even though not shown in FIGS. 6A and 6B, the sliding process may continue till all the data points in the tensor 410 are produced.

FIGS. 7A-7D illustrate a resized and dilated convolution, in accordance with various embodiments. The resized and dilated convolution may be in a layer of a DNN. In the embodiments of FIGS. 7A-7D, the resized and dilated convolution has a dilation rate D=2, kernel size K=2, stride size s=2, and padding size p=2. In FIG. 7A, an upsampled input tensor 710 is generated from an input tensor 715 of the resized and dilated convolution by a padding process based on the padding size, in which two rows of zeros are added to both the right and the left of the input tensor and two rows of zeros are added to both the top and bottom of the input tensor. The input tensor 715 has a size of 6×6, and the upsampled input tensor 710 has a dimension of 10×10.

In FIG. 7B, a kernel 725 of the resized and dilated convolution is dilated based on the dilation rate. Given the dilation rate D=2, a row of zeros is added between every two neighboring rows in the kernel 725. Also, a column of zeros is added between every two neighboring columns in the kernel 725. A dilated kernel 720 is generated. The kernel 725 has a dimension of 3×3, and the dilated kernel 720 has a dimension of 5×5.

The resized and dilated convolution may be a convolution that includes applying the dilated kernel 720 on the upsampled input tensor 710. The resized and dilated convolution may be accelerated by avoiding computations on the inserted zeros, as the zeros may not contribute to the output of the resized and dilated convolution. To accelerate the resized and dilated convolution, the resized and dilated convolution is converted to four convolutions. As shown in FIG. 7C, four input tensors 730A-730D (collectively referred to as “input tensors 730” or “input tensor 730”). Each input tensor 730 is smaller than the upsampled input tensor 710, so each convolution on an input tensor 730 would be smaller than the convolution on the upsampled input tensor 710.

An input tensor 730 includes zeros on its four edges as well as nine data elements from the input tensor 715. In FIG. 7C, the data elements from the input tensor 715 are represented by patterned squares in FIG. 7A, and the zeros are represented by empty squares. The kernel for a convolution on an input tensor 730 may be the kernel 725. In some embodiments, the data elements of an input tensor 730 may be identified based on one or more sparsity maps, e.g., sparsity maps generated by the DNN module 201 based on the padding size, kernel size, and dilation rate. The one or more sparsity maps may include a sparsity map corresponding to at least part of the upsampled input tensor 710, a sparsity map corresponding to at least part of the dilated kernel 720, or a combined sparsity map. An element in a sparsity map may correspond to a data element in the upsampled input tensor 710 and indicate whether the data element is from the input tensor 715 or is a zero added to the input tensor 715 for expanding the input tensor 715. An input tensor 730 may also be associated with one or more storage pointers that indicate locations in a memory (e.g., the local memory 240) where the data elements from the input tensor 715 are stored in the memory. The sparsity bitmap(s) and storage pointer(s) may be used to feed the data elements stored in the memory to one or more PEs that perform the convolution on the input tensor 715.

In FIG. 7D, the convolutions on the input tensors 730A-730D generate output tensors 740A-740D (collectively referred to as “output tensors 740” or “output tensor 740”), respectively. Each output tensor has a size of 3×3. The output tensors 740 are combined to generate a combined output tensor 750. The combined output tensor 750 may be the output of the resized and dilated convolution. The position of a data element in the output tensor 750 may be determined based on one or more sparsity maps. The one or more sparsity maps may include a sparsity map corresponding to at least part of the upsampled input tensor 710, a sparsity map corresponding to at least part of the dilated kernel 720, or a combined sparsity map. In some embodiments, storage pointers of the data elements in the combined output tensor 750 may be generated and used for the deep learning operation in the next layer of the DNN.

### Example Convolution

FIG. 8 illustrates an example convolution, in accordance with various embodiments. In some embodiments, the convolution may be a convolution in a convolutional layer of a DNN, e.g., a convolutional layer 110 in FIG. 1. In other embodiments, the convolution may be converted from a convolution variant, e.g., a transposed, resized, or dilated convolution. In the embodiments of FIG. 8, the convolution can be executed on an input tensor 810 and filters 820 (individually referred to as “filter 820”). The result of the convolution is an output tensor 830. In some embodiments, the convolution is performed by a DNN accelerator. An example of the DNN accelerator may be the DNN accelerator 202 in FIG. 2.

In the embodiments of FIG. 8, the input tensor 810 includes activations (also referred to as “input activations,” “elements,” or “input elements”) arranged in a three-dimensional (3D) matrix. An input element is a data point in the input tensor 810. The input tensor 810 has a spatial size Hᵢₙ×Wᵢₙ×Cᵢₙ, where Hᵢₙ is the height of the 3D matrix (i.e., the length along the Y axis, which indicates the number of activations in a column in the 3D matrix of each input channel), Wᵢₙ is the width of the 3D matrix (i.e., the length along the X-axis, which indicates the number of activations in a row in the 3D matrix of each input channel), and Cᵢₙ is the depth of the 3D matrix (i.e., the length along the Z axis, which indicates the number of input channels). For the purpose of simplicity and illustration, the input tensor 810 has a spatial size of 7×7×3, i.e., the input tensor 810 includes three input channels and each input channel has a 7×7 3D matrix. Each input element in the input tensor 810 may be represented by a (X, Y, Z) coordinate. In other embodiments, the height, width, or depth of the input tensor 810 may be different.

Each filter 820 includes weights arranged in a 3D matrix. The values of the weights may be determined through training the DNN. A filter 820 has a spatial size H_{f}×W_{f}×C_{f}, where H_{f} is the height of the filter (i.e., the length along the Y axis, which indicates the number of weights in a column in each kernel), W_{f} is the width of the filter (i.e., the length along the X-axis, which indicates the number of weights in a row in each kernel), and C_{f} is the depth of the filter (i.e., the length along the Z axis, which indicates the number of channels). In some embodiments, C_{f} equals Cᵢₙ. For purpose of simplicity and illustration, each filter 820 in FIG. 8 has a spatial size of 8×3×3, i.e., the filter 820 includes 8 convolutional kernels with a spatial size of 8×3. In other embodiments, the height, width, or depth of the filter 820 may be different. The spatial size of the convolutional kernels is smaller than the spatial size of the 3D matrix of each input channel in the input tensor 810.

An activation or weight may take one or more bytes in a memory. The number of bytes for an activation or weight may depend on the data format. For example, when the activation or weight has an INT8 format, the activation takes one byte. When the activation or weight has a FP16 format, the activation or weight takes two bytes. Other data formats may be used for activations or weights.

In the convolution, each filter 820 slides across the input tensor 810 and generates a 3D matrix for an output channel in the output tensor 830. In the embodiments of FIG. 8, the 3D matrix has a spatial size of 5×5. The output tensor 830 includes activations (also referred to as “output activations,” “elements,” or “output element”) arranged in a 3D matrix. An output activation is a data point in the output tensor 830. The output tensor 830 has a spatial size Hₒᵤₜ×Wₒᵤₜ×Cₒᵤₜ, where Hₒᵤₜ is the height of the 3D matrix (i.e., the length along the Y axis, which indicates the number of output activations in a column in the 3D matrix of each output channel), Wₒᵤₜ is the width of the 3D matrix (i.e., the length along the X-axis, which indicates the number of output activations in a row in the 3D matrix of each output channel), and Cₒᵤₜ is the depth of the 3D matrix (i.e., the length along the Z axis, which indicates the number of output channels). Cₒᵤₜ may equal the number of filters 820 in the convolution. Hₒᵤₜ and Wₒᵤₜ may depend on the heights and weights of the input tensor 810 and each filter 820.

As a part of the convolution, MAC operations can be performed on a 8×3×3 subtensor 815 (which is highlighted with a dotted pattern in FIG. 8) in the input tensor 810 and each filter 820. The result of the MAC operations on the subtensor 815 and one filter 820 is an output activation. In some embodiments (e.g., embodiments where the convolution is an integral convolution), an output activation may include 8 bits, e.g., one byte. In other embodiments (e.g., embodiments where the convolution is a floating-point convolution), an output activation may include more than one byte. For instance, an output element may include two bytes.

After the MAC operations on the subtensor 815 and all the filters 820 are finished, a vector 835 is produced. The vector 835 is highlighted with slashes in FIG. 8. The vector 835 includes a sequence of output activations, which are arranged along the Z axis. The output activations in the vector 835 have the same (x, y) coordinate, but the output activations correspond to different output channels and have different Z coordinates. The dimension of the vector 835 along the Z axis may equal the total number of output channels in the output tensor 830. After the vector 835 is produced, further MAC operations are performed to produce additional vectors till the output tensor 830 is produced.

In some embodiments, the MAC operations on a 8×3×3 subtensor (e.g., the subtensor 815) and a filter 820 may be performed by a plurality of PEs. One or more PEs may receive an input operand (e.g., an input operand 817 shown in FIG. 8) and a weight operand (e.g., the weight operand 827 shown in FIG. 8). The input operand 817 includes a sequence of activations having the same (x, y) coordinate but different z coordinates. The input operand 817 includes an activation from each of the input channels in the input tensor 810. The weight operand 827 includes a sequence of weights having the same (x, y) coordinate but different z coordinates. The weight operand 827 includes a weight from each of the channels in the filter 820. Activations in the input operand 817 and weights in the weight operand 827 may be sequentially fed into a PE. The PE may receive an activation and a weight (“an activation-weight pair”) at a time and multiple the activation and the weight. The position of the activation in the input operand 817 may match the position of the weight in the weight operand 827. The activation and weight may correspond to the same channel.

Activations or weights may be floating-point numbers. Floating-point numbers may have various data formats, such as FP32, FP16, BF16, and so on. A floating-point number may be a positive or negative number with a decimal point. A floating-point number may be represented by a sequence of bits that includes one or more bits representing the sign of the floating-point number (e.g., positive or negative), bits representing an exponent of the floating-point number, and bits representing a mantissa of the floating-point number. The mantissa is the part of a floating-point number that represents the significant digits of that number. The mantissa is multiplied by the base raised to the exponent to give the actual value of the floating-point number.

In some embodiments, the output activations in the output tensor 830 may be further processed based on one or more activation functions before they are stored or inputted into the next layer of the DNN. The processing based on the one or more activation functions may be at least part of the post processing of the convolution. In some embodiments, the post processing may include one or more other computations, such as offset computation, bias computation, and so on. The results of the post processing may be stored in a local memory of the compute block and be used as input to the next DNN layer. In some embodiments, the input activations in the input tensor 810 may be results of post processing of the previous DNN layer.

### Example PE Array

FIG. 9 illustrates an example PE array, in accordance with various embodiments. The PE array 900 may be an embodiment of the PE array 250 in FIG. 3, The PE array 900 includes a plurality of PEs 910 (individually referred to as “PE 910”). The PEs 910 can perform MAC operations, including MAC operations in quantized inference. The PEs 910 may also be referred to as neurons in the DNN. Each PE 910 has two input signals 950 and 960 and an output signal 970. The input signal 950 is at least a portion of an IFM to the layer. The input signal 960 is at least a portion of a filter of the layer. In some embodiments, the input signal 950 of a PE 910 includes one or more input operands, and the input signal 960 includes one or more weight operands.

Each PE 910 performs an MAC operation on the input signals 950 and 960 and outputs the output signal 970, which is a result of the MAC operation. Some or all of the input signals 950 and 960 and the output signal 970 may be in an integer format, such as INT8, or floating-point format, such as FP16 or BF16. For the purpose of simplicity and illustration, the input signals and output signal of all the PEs 910 have the same reference numbers, but the PEs 910 may receive different input signals and output different output signals from each other. Also, a PE 910 may be different from another PE 910, e.g., including more, fewer, or different components.

As shown in FIG. 9, the PEs 910 are connected to each other, as indicated by the dash arrows in FIG. 9. The output signal 970 of an PE 910 may be sent to many other PEs 910 (and possibly back to itself) as input signals via the interconnections between PEs 910. In some embodiments, the output signal 970 of an PE 910 may incorporate the output signals of one or more other PEs 910 through an accumulate operation of the PE 910 and generates an internal partial sum of the PE array.

In the embodiments of FIG. 9, the PEs 910 are arranged into columns 905 (individually referred to as “column 905”). The input and weights of the layer may be distributed to the PEs 910 based on the columns 905. Each column 905 has a column buffer 920. The column buffer 920 stores data provided to the PEs 910 in the column 905 for a short amount of time. The column buffer 920 may also store data output by the last PE 910 in the column 905. The output of the last PE 910 may be a sum of the MAC operations of all the PEs 910 in the column 905, which is a column-level internal partial sum of the PE array 900. In other embodiments, input and weights may be distributed to the PEs 910 based on rows in the PE array 900. The PE array 900 may include row buffers in lieu of column buffers 920. A row buffer may store input signals of the PEs in the corresponding row and may also store a row-level internal partial sum of the PE array 900.

In some embodiments, a column buffer 920 may be a portion of the local memory 240 in FIG. 3. The column buffer 920 may be associated with upper memory hierarchies, e.g., the memory 210 in FIG. 3. Data in the column buffer 920 may be sent to the upper memory hierarchies. The column buffer 920 may receive data from the upper memory hierarchies.

FIG. 10 is a block diagram of a PE 1000, in accordance with various embodiments. The PE 1000 may be an embodiment of the PE 910 in FIG. 9. The PE 1000 may perform MAC operations, e.g., MAC operations using data in integer formats. The PE 1000 may be an example PE in the PE array 250 described above in conjunction with FIG. 3. As shown in FIG. 10, the PE 1000 includes input register files 1010 (individually referred to as “input register file 1010”), weight registers file 1020 (individually referred to as “weight register file 1020”), multipliers 1030 (individually referred to as “multiplier 1030”), an internal adder assembly 1040, and an output register file 1050. In other embodiments, the PE 1000 may include fewer, more, or different components. For example, the PE 1000 may include multiple output register files 1050. As another example, the PE 1000 may include a single input register file 1010, weight register file 1020, or multiplier 1030. As yet another example, the PE 1000 may include an adder in lieu of the internal adder assembly 1040.

The input register files 1010 temporarily store input operands for MAC operations by the PE 1000. In some embodiments, an input register file 1010 may store a single input operand at a time. In other embodiments, an input register file 1010 may store multiple input operand or a portion of an input operand at a time. An input operand includes a plurality of input elements (i.e., input elements) in an input tensor. The input elements of an input operand may be stored sequentially in the input register file 1010 so the input elements can be processed sequentially. In some embodiments, each input element in the input operand may be from a different input channel of the input tensor. The input operand may include an input element from each of the input channels of the input tensor, and the number of input elements in an input operand may equal the number of the input channels. The input elements in an input operand may have the same (X, Y) coordinates, which may be used as the (X, Y) coordinates of the input operand. For instance, all the input elements of an input operand may be X0Y0, X0Y1, X1Y1, etc.

The weight register file 1020 temporarily stores weight operands for MAC operations by the PE 1000. The weight operands include weights in the filters of the DNN layer. In some embodiments, the weight register file 1020 may store a single weight operand at a time. other embodiments, an input register file 1010 may store multiple weight operands or a portion of a weight operand at a time. A weight operand may include a plurality of weights. The weights of a weight operand may be stored sequentially in the weight register file 1020 so the weight can be processed sequentially. In some embodiments, for a multiplication operation that involves a weight operand and an input operand, each weight in the weight operand may correspond to an input element of the input operand. The number of weights in the weight operand may equal the number of the input elements in the input operand.

In some embodiments, a weight register file 1020 may be the same or similar as an input register file 1010, e.g., having the same size, etc. The PE 1000 may include a plurality of register files, some of which are designated as the input register files 1010 for storing input operands, some of which are designated as the weight register files 1020 for storing weight operands, and some of which are designated as the output register file 1050 for storing output operands. In other embodiments, register files in the PE 1000 may be designated for other purposes, e.g., for storing scale operands used in elementwise add operations, etc.

The multipliers 1030 perform multiplication operations on input operands and weight operands. A multiplier 1030 may perform a sequence of multiplication operations on a single input operand and a single weight operand and generate a product operand including a sequence of products. Each multiplication operation in the sequence includes multiplying an input element in the input operand and a weight in the weight operand. In some embodiments, a position (or index) of the input element in the input operand matches the position (or index) of the weight in the weight operand. For instance, the first multiplication operation is a multiplication of the first input element in the input operand and the first weight in the weight operand, the second multiplication operation is a multiplication of the second input element in the input operand and the second weight in the weight operand, the third multiplication operation is a multiplication of the third input element in the input operand and the third weight in the weight operand, and so on. The input element and weight in the same multiplication operation may correspond to the same depthwise channel, and their product may also correspond to the same depthwise channel.

Multiple multipliers 1030 may perform multiplication operations simultaneously. These multiplication operations may be referred to as a round of multiplication operations. In a round of multiplication operations by the multipliers 1030, each of the multipliers 1030 may use a different input operand and a different weight operand. The different input operands or weight operands may be stored in different register files of the PE 1000. For instance, a first multiplier 1030 uses a first input operand (e.g., stored in a first input register file 1010) and a first weight operand (e.g., stored in a first weight register file 1020), versus a second multiplier 1030 uses a second input operand (e.g., stored in a second input register file 1010) and a second weight operand (e.g., stored in a second weight register file 1020), a third multiplier 1030 uses a third input operand (e.g., stored in a third input register file 1010) and a third weight operand (e.g., stored in a third weight register file 1020), and so on. For an individual multiplier 1030, the round of multiplication operations may include a plurality of cycles. A cycle includes a multiplication operation on an input element and a weight.

The multipliers 1030 may perform multiple rounds of multiplication operations. A multiplier 1030 may use the same weight operand but different input operands in different rounds. For instance, the multiplier 1030 performs a sequence of multiplication operations on a first input operand stored in a first input register file in a first round, versus a second input operand stored in a second input register file in a second round. In the second round, a different multiplier 1030 may use the first input operand and a different weight operand to perform another sequence of multiplication operations. That way, the first input operand is reused in the second round. The first input operand may be further reused in additional rounds, e.g., by additional multipliers 1030.

The internal adder assembly 1040 includes one or more adders inside the PE 1000, i.e., internal adders. The internal adder assembly 1040 may perform accumulation operations on two or more products operands from multipliers 1030 and produce an output operand of the PE 1000. In some embodiments, the internal adders are arranged in a sequence of tiers. A tier includes one or more internal adders. For the first tier of the internal adder assembly 1040, an internal adder may receive product operands from two or more multipliers 1030 and generate a sum operand through a sequence of accumulation operations. Each accumulation operation produces a sum of two or more products, each of which is from a different multiplier 1030. The sum operand includes a sequence of sums, each of which is a result of an accumulation operation and corresponds to a depthwise channel. For the other tier(s) of the internal adder assembly 1040, an internal adder in a tier receives sum operands from the precedent tier in the sequence. Each of these numbers may be generated by a different internal adder in the precedent tier. A ratio of the number of internal adders in a tier to the number of internal adders in a subsequent tier may be 2:1. In some embodiments, the last tier of the internal adder assembly 1040 may include a single internal adder, which produces the output operand of the PE 1000.

The output register file 1050 stores output operands of the PE 1000. In some embodiments, the output register file 1050 may store an output operand at a time. In other embodiments, the output register file 1050 may store multiple output operands or a portion of an output operand at a time. An output operand includes a plurality of output elements in an IFM. The output elements of an output operand may be stored sequentially in the output register file 1050 so the output elements can be processed sequentially. In some embodiments, each output element in the output operand corresponds to a different depthwise channel and is an element of a different output channel of the output channel of the depthwise convolution. The number of output elements in an output operand may equal the number of the depthwise channels of the depthwise convolution.

### Example Method of Performing Deep Learning Operation

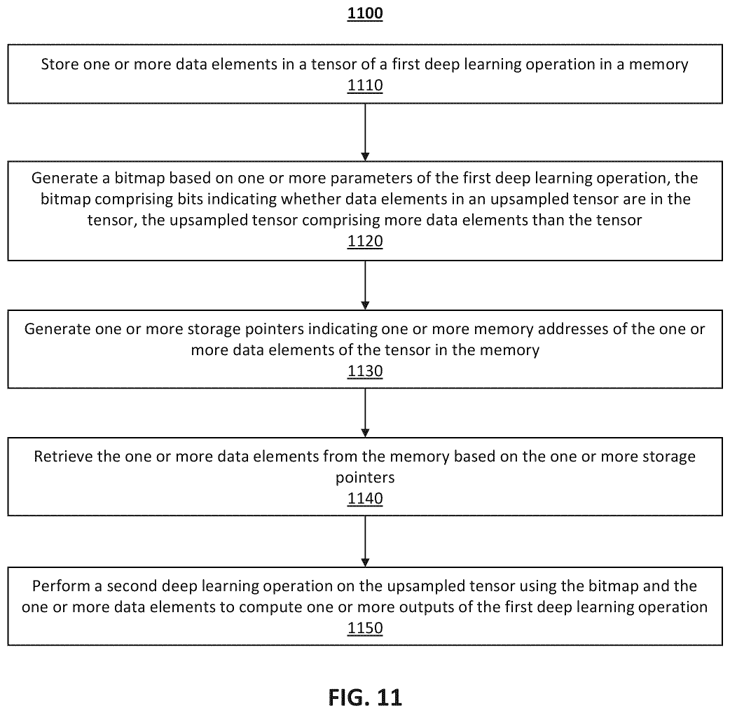

FIG. 11 is a flowchart showing a method 1100 of performing deep learning operations, in accordance with various embodiments. The method 1100 may be performed by the DNN module 201 in FIG. 5. Although the method 1100 is described with reference to the flowchart illustrated in FIG. 11, many other methods for pruning weight may alternatively be used. For example, the order of execution of the steps in FIG. 11 may be changed. As another example, some of the steps may be changed, eliminated, or combined.

The DNN module 201 stores 1110 one or more data elements in a tensor of a first deep learning operation in a memory. The one or more data elements may be one or more activations and may be in a vector having a size of 1×1×N, where N is the number of data elements in the vector. The tensor may be an input tensor of the deep learning operation. The deep learning operation may be a transposed convolution.

The DNN module 201 generates 1120 a bitmap based on one or more parameters of the first deep learning operation. The bitmap comprises bits indicating whether data elements in an upsampled tensor are in the tensor. The upsampled tensor comprises more data elements than the tensor. In some embodiments, the DNN module 201 determines one or more positions where one or more additional elements are inserted into the tensor based on the one or more parameters. The DNN module 201 generates the bitmap based on the one or more positions.

In some embodiments, the bitmap comprises one or more bits and one or more additional bits. The one or more bits have a first value and correspond to the one or more elements. The one or more additional bits have a second value and correspond to the one or more additional elements. The first value is different from the second value. In some embodiments, the one or more parameters of the first deep learning operation comprises a padding size, a kernel size, a stride size, or a dilation rate of the first deep learning operation.

The DNN module 201 generates 1130 one or more storage pointers indicating one or more memory addresses of the one or more data elements of the tensor in the memory. In some embodiments, a storage pointer may store information indicating the location of a storage element. The storage element may store one or more data elements. In some embodiments, a storage element may include one or more banks in the memory. In other embodiments, a storage element may be a portion of a bank in the memory, such as one or more storage units in the bank.

The DNN module 201 retrieves 1140 the one or more data elements from the memory based on the one or more storage pointers. In some embodiments, the one or more data elements are in the same channel (e.g., the same input channel) of the first deep learning operation.

The DNN module 201 performs 1150 a second deep learning operation on the upsampled tensor using the bitmap and the one or more data elements to compute one or more outputs of the first deep learning operation. In some embodiments, the first deep learning operation is an inverse convolution, and a second deep learning operation is a convolution.

In some embodiments, the tensor is an input tensor of the convolution. The one or more outputs are in an output tensor of the convolution. A dimension of the output tensor of the convolution is smaller than a dimension of the upsampled tensor but larger than a dimension of the input tensor.

### Example Computing Device

FIG. 12 is a block diagram of an example computing device 1200, in accordance with various embodiments. In some embodiments, the computing device 1200 can be used as at least part of the DNN system 200. A number of components are illustrated in FIG. 12 as included in the computing device 1200, but any one or more of these components may be omitted or duplicated, as suitable for the application. In some embodiments, some or all of the components included in the computing device 1200 may be attached to one or more motherboards. In some embodiments, some or all of these components are fabricated onto a single system on a chip (SoC) die. Additionally, in various embodiments, the computing device 1200 may not include one or more of the components illustrated in FIG. 12, but the computing device 1200 may include interface circuitry for coupling to the one or more components. For example, the computing device 1200 may not include a display device 1206, but may include display device interface circuitry (e.g., a connector and driver circuitry) to which a display device 1206 may be coupled. In another set of examples, the computing device 1200 may not include an audio input device 1218 or an audio output device 1208, but may include audio input or output device interface circuitry (e.g., connectors and supporting circuitry) to which an audio input device 1218 or audio output device 1208 may be coupled.

The computing device 1200 may include a processing device 1202 (e.g., one or more processing devices). The processing device 1202 processes electronic data from registers and/or memory to transform that electronic data into other electronic data that may be stored in registers and/or memory. The computing device 1200 may include a memory 1204, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 1204 may include memory that shares a die with the processing device 1202. In some embodiments, the memory 1204 includes one or more non-transitory computer-readable media storing instructions executable to perform deep learning operations, e.g., the method 1100 described above in conjunction with FIG. 11 or some operations performed by the DNN module 201 described above in conjunction with FIG. 3. The instructions stored in the one or more non-transitory computer-readable media may be executed by the processing device 1202.

In some embodiments, the computing device 1200 may include a communication chip 1212 (e.g., one or more communication chips). For example, the communication chip 1212 may be configured for managing wireless communications for the transfer of data to and from the computing device 1200. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

The communication chip 1212 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 1212 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 1212 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 1212 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 1212 may operate in accordance with other wireless protocols in other embodiments. The computing device 1200 may include an antenna 1222 to facilitate wireless communications and/or to receive other wireless communications (such as AM or FM radio transmissions).

In some embodiments, the communication chip 1212 may manage wired communications, such as electrical, optical, or any other suitable communication protocols (e.g., the Ethernet). As noted above, the communication chip 1212 may include multiple communication chips. For instance, a first communication chip 1212 may be dedicated to shorter-range wireless communications such as Wi-Fi or Bluetooth, and a second communication chip 1212 may be dedicated to longer-range wireless communications such as global positioning system (GPS), EDGE, GPRS, CDMA, WiMAX, LTE, EV-DO, or others. In some embodiments, a first communication chip 1212 may be dedicated to wireless communications, and a second communication chip 1212 may be dedicated to wired communications.

The computing device 1200 may include battery/power circuitry 1214. The battery/power circuitry 1214 may include one or more energy storage devices (e.g., batteries or capacitors) and/or circuitry for coupling components of the computing device 1200 to an energy source separate from the computing device 1200 (e.g., AC line power).

The computing device 1200 may include a display device 1206 (or corresponding interface circuitry, as discussed above). The display device 1206 may include any visual indicators, such as a heads-up display, a computer monitor, a projector, a touchscreen display, a liquid crystal display (LCD), a light-emitting diode display, or a flat panel display, for example.

The computing device 1200 may include an audio output device 1208 (or corresponding interface circuitry, as discussed above). The audio output device 1208 may include any device that generates an audible indicator, such as speakers, headsets, or earbuds, for example.

The computing device 1200 may include an audio input device 1218 (or corresponding interface circuitry, as discussed above). The audio input device 1218 may include any device that generates a signal representative of a sound, such as microphones, microphone arrays, or digital instruments (e.g., instruments having a musical instrument digital interface (MIDI) output).

The computing device 1200 may include a GPS device 1216 (or corresponding interface circuitry, as discussed above). The GPS device 1216 may be in communication with a satellite-based system and may receive a location of the computing device 1200, as known in the art.

The computing device 1200 may include another output device 1210 (or corresponding interface circuitry, as discussed above). Examples of the other output device 1210 may include an audio codec, a video codec, a printer, a wired or wireless transmitter for providing information to other devices, or an additional storage device.

The computing device 1200 may include another input device 1220 (or corresponding interface circuitry, as discussed above). Examples of the other input device 1220 may include an accelerometer, a gyroscope, a compass, an image capture device, a keyboard, a cursor control device such as a mouse, a stylus, a touchpad, a bar code reader, a Quick Response (OR) code reader, any sensor, or a radio frequency identification (RFID) reader.

The computing device 1200 may have any desired form factor, such as a handheld or mobile computer system (e.g., a cell phone, a smart phone, a mobile internet device, a music player, a tablet computer, a laptop computer, a netbook computer, an ultrabook computer, a personal digital assistant (PDA), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 1200 may be any other electronic device that processes data.

### Selected Examples

The following paragraphs provide various examples of the embodiments disclosed herein.

Example 1 provides a method for deep learning operations, the method including storing one or more data elements in a tensor of a first deep learning operation in a memory; generating a bitmap based on one or more parameters of the first deep learning operation, the bitmap including bits indicating whether data elements in an upsampled tensor are in the tensor, the upsampled tensor including more data elements than the tensor; generating one or more storage pointers indicating one or more memory addresses of the one or more data elements of the tensor in the memory; retrieving the one or more data elements from the memory based on the one or more storage pointers; and performing one or more second deep learning operations on the upsampled tensor using the bitmap and the one or more data elements to compute one or more outputs of the first deep learning operation.

Example 2 provides the method of example 1, where the first deep learning operation is a transposed convolution or a dilated convolution, and a second deep learning operation is a convolution.

Example 3 provides the method of example 2, where the tensor is an input tensor of the convolution, the one or more outputs are in an output tensor of the convolution, and a dimension of the output tensor of the convolution is smaller than a dimension of the upsampled tensor but larger than a dimension of the input tensor.

Example 4 provides the method of any of the preceding examples, where generating the bitmap based on the one or more parameters of the first deep learning operation includes determining one or more positions where one or more additional elements are inserted into the tensor based on the one or more parameters; and generating the bitmap based on the one or more positions.

Example 5 provides the method of example 4, where the bitmap includes one or more bits and one or more additional bits, the one or more bits have a first value and correspond to the one or more elements, the one or more additional bits have a second value and correspond to the one or more additional elements, and the first value is different from the second value.

Example 6 provides the method of any of the preceding examples, where the one or more parameters of the first deep learning operation includes a padding size, a kernel size, a stride size, or a dilation rate of the first deep learning operation.

Example 7 provides the method of any of the preceding examples, where the one or more data elements are in a same channel of the first deep learning operation.

Example 8 provides one or more non-transitory computer-readable media storing instructions executable to perform operations, the operations including storing one or more data elements in a tensor of a first deep learning operation in a memory; generating a bitmap based on one or more parameters of the first deep learning operation, the bitmap including bits indicating whether data elements in an upsampled tensor are in the tensor, the upsampled tensor including more data elements than the tensor; generating one or more storage pointers indicating one or more memory addresses of the one or more data elements of the tensor in the memory; retrieving the one or more data elements from the memory based on the one or more storage pointers; and performing one or more second deep learning operations on the upsampled tensor using the bitmap and the one or more data elements to compute one or more outputs of the first deep learning operation.

Example 9 provides the one or more non-transitory computer-readable media of example 8, where the first deep learning operation is a transposed convolution or a dilated convolution, and a second deep learning operation is a convolution.

Example 10 provides the one or more non-transitory computer-readable media of example 9, where the tensor is an input tensor of the convolution, the one or more outputs are in an output tensor of the convolution, and a dimension of the output tensor of the convolution is smaller than a dimension of the upsampled tensor but larger than a dimension of the input tensor.

Example 11 provides the one or more non-transitory computer-readable media of any one of examples 8-10, where generating the bitmap based on the one or more parameters of the first deep learning operation includes determining one or more positions where one or more additional elements are inserted into the tensor based on the one or more parameters; and generating the bitmap based on the one or more positions.

Example 12 provides the one or more non-transitory computer-readable media of example 11, where the bitmap includes one or more bits and one or more additional bits, the one or more bits have a first value and correspond to the one or more elements, the one or more additional bits have a second value and correspond to the one or more additional elements, and the first value is different from the second value.

Example 13 provides the one or more non-transitory computer-readable media of any one of examples 8-12, where the one or more parameters of the first deep learning operation includes a padding size, a kernel size, a stride size, or a dilation rate of the first deep learning operation.

Example 14 provides the one or more non-transitory computer-readable media of any one of examples 8-13, where the one or more data elements are in a same channel of the first deep learning operation.

Example 15 provides an apparatus, including a computer processor for executing computer program instructions; and a non-transitory computer-readable memory storing computer program instructions executable by the computer processor to perform operations including storing one or more data elements in a tensor of a first deep learning operation in a memory, generating a bitmap based on one or more parameters of the first deep learning operation, the bitmap including bits indicating whether data elements in an upsampled tensor are in the tensor, the upsampled tensor including more data elements than the tensor, generating one or more storage pointers indicating one or more memory addresses of the one or more data elements of the tensor in the memory, retrieving the one or more data elements from the memory based on the one or more storage pointers, and performing one or more second deep learning operations on the upsampled tensor using the bitmap and the one or more data elements to compute one or more outputs of the first deep learning operation.

Example 16 provides the apparatus of example 15, where the first deep learning operation is a transposed convolution or a dilated convolution, and a second deep learning operation is a convolution.

Example 17 provides the apparatus of example 16, where the tensor is an input tensor of the convolution, the one or more outputs are in an output tensor of the convolution, and a dimension of the output tensor of the convolution is smaller than a dimension of the upsampled tensor but larger than a dimension of the input tensor.

Example 18 provides the apparatus of any one of examples 15-17, where generating the bitmap based on the one or more parameters of the first deep learning operation includes determining one or more positions where one or more additional elements are inserted into the tensor based on the one or more parameters; and generating the bitmap based on the one or more positions.

Example 19 provides the apparatus of example 18, where the bitmap includes one or more bits and one or more additional bits, the one or more bits have a first value and correspond to the one or more elements, the one or more additional bits have a second value and correspond to the one or more additional elements, and the first value is different from the second value.

Example 20 provides the apparatus of any one of examples 15-19, where the one or more parameters of the first deep learning operation includes a padding size, a kernel size, a stride size, or a dilation rate of the first deep learning operation.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. A method for deep learning operations, the method comprising:
storing one or more data elements in a tensor of a first deep learning in a memory;
generating a bitmap based on one or more parameters of the first deep learning operation, the bitmap comprising bits indicating whether data elements in an upsampled tensor are in the tensor, the upsampled tensor comprising one or more data elements than the tensor;
generating one or more storage pointers indicating one or more memory addresses of the one or more data elements of the tensor in the memory;
retrieving the one or more data elements from the memory based on the one or more storage pointers; and
performing one or more second deep learning operations on the upsampled tensor using the bitmap and the one or more data elements to compute one or more outputs of the first deep learning operation.

2. The method of claim 1, wherein the first deep learning operation is a transposed convolution or a dilated convolution, and a second deep learning operation is a convolution.

3. The method of claim 2, wherein the tensor is an input tensor of the convolution, the one or more outputs are in an output tensor of the convolution, and a dimension of the output tensor of the convolution is smaller than a dimension of the upsampled tensor but larger than a dimension of the input tensor.

4. The method of claim 1, wherein generating the bitmap based on the one or more parameters of the first deep learning operation comprises:
determining one or more positions where one or more additional elements are inserted into the tensor based on the one or more parameters; and
generating the bitmap based on the one or more positions.

5. The method of claim 4, wherein:
the bitmap comprises one or more bits and one or more additional bits,
the one or more bits have a first value and correspond to the one or more elements,
the one or more additional bits have a second value and correspond to the one or more additional elements, and
the first value is different from the second value.

6. The method of claim 1, wherein the one or more parameters of the first deep learning operation comprises a padding size, a kernel size, a stride size, or a dilation rate of the first deep learning operation.

7. The method of claim 1, wherein the one or more data elements are in a same channel of the first deep learning operation.

8. One or more non-transitory computer-readable media storing instructions executable to perform operations, the operations comprising:
storing one or more data elements in a tensor of a first deep learning operation in a memory;
generating a bitmap based on one or more parameters of the first deep learning operation, the bitmap comprising bits indicating whether data elements in an upsampled tensor are in the tensor, the upsampled tensor comprising one or more data elements than the tensor;
generating one or more storage pointers indicating one or more memory addresses of the one or more data elements of the tensor in the memory;
retrieving the one or more data elements from the memory based on the one or more storage pointers; and
performing one or more second deep learning operations on the upsampled tensor using the bitmap and the one or more data elements to compute one or more outputs of the first deep learning operation.

9. The one or more non-transitory computer-readable media of claim 8, wherein the first deep learning operation is a transposed convolution or a dilated convolution, and a second deep learning operation is a convolution.

10. The one or more non-transitory computer-readable media of claim 9, wherein the tensor is an input tensor of the convolution, the one or more outputs are in an output tensor of the convolution, and a dimension of the output tensor of the convolution is smaller than a dimension of the upsampled tensor but larger than a dimension of the input tensor.

11. The one or more non-transitory computer-readable media of claim 8, wherein generating the bitmap based on the one or more parameters of the first deep learning operation comprises:
determining one or more positions where one or more additional elements are inserted into the tensor based on the one or more parameters; and
generating the bitmap based on the one or more positions.

12. The one or more non-transitory computer-readable media of claim 11, wherein:
the bitmap comprises one or more bits and one or more additional bits,
the one or more bits have a first value and correspond to the one or more elements,
the one or more additional bits have a second value and correspond to the one or more additional elements, and
the first value is different from the second value.

13. The one or more non-transitory computer-readable media of claim 8, wherein the one or more parameters of the first deep learning operation comprises a padding size, a kernel size, a stride size, or a dilation rate of the first deep learning operation.

14. The one or more non-transitory computer-readable media of claim 8, wherein the one or more data elements are in a same channel of the first deep learning operation.

15. An apparatus, comprising:
a computer processor for executing computer program instructions; and
a non-transitory computer-readable memory storing computer program instructions executable by the computer processor to perform operations comprising:
storing one or more data elements in a tensor of a first deep learning operation in a memory,
generating a bitmap based on one or more parameters of the first deep learning operation, the bitmap comprising bits indicating whether data elements in an upsampled tensor are in the tensor, the upsampled tensor comprising one or more data elements than the tensor,
generating one or more storage pointers indicating one or more memory addresses of the one or more data elements of the tensor in the memory,
retrieving the one or more data elements from the memory based on the one or more storage pointers, and
performing one or more second deep learning operations on the upsampled tensor using the bitmap and the one or more data elements to compute one or more outputs of the first deep learning operation.

16. The apparatus of claim 15, wherein the first deep learning operation is a transposed convolution or a dilated convolution, and a second deep learning operation is a convolution.

17. The apparatus of claim 16, wherein the tensor is an input tensor of the convolution, the one or more outputs are in an output tensor of the convolution, and a dimension of the output tensor of the convolution is smaller than a dimension of the upsampled tensor but larger than a dimension of the input tensor.

18. The apparatus of claim 15, wherein generating the bitmap based on the one or more parameters of the first deep learning operation comprises:
determining one or more positions where one or more additional elements are inserted into the tensor based on the one or more parameters; and
generating the bitmap based on the one or more positions.

19. The apparatus of claim 18, wherein:
the bitmap comprises one or more bits and one or more additional bits,
the one or more bits have a first value and correspond to the one or more elements,
the one or more additional bits have a second value and correspond to the one or more additional elements, and
the first value is different from the second value.

20. The apparatus of claim 15, wherein the one or more parameters of the first deep learning operation comprises a padding size, a kernel size, a stride size, or a dilation rate of the first deep learning operation.
